(19) United States
(12) Patent Application Publication
(10) Pub. No.: US 2026/0154051 A1
(43) Pub. Date: Jun. 4, 2026

(54) METHODS AND APPARATUS TO GENERATE AND/OR UTILIZE HINTS IN TIERED MEMORIES AND STORAGE

(71) Applicant: Openchip & Software Technologies S.L., Barcelona (ES)

(72) Inventors: Francesc Guim Bernat, Barcelona (ES); Edgar Gonzàlez Pellicer, Barcelona (ES); Gaspar Mora Porta, Castellon de la Plana (ES); Erich Ludwig Focht, Stuttgart (DE); Tommaso Vali, Sezze (IT); Violante Moschiano, Avezzano (IT)

(21) Appl. No.: 19/402,658

(22) Filed: Nov. 26, 2025

Related U.S. Application Data
(63) Continuation of application No. PCT/EP2025/081013, filed on Oct. 27, 2025.

(51) Int. Cl. G06F 8/41; G06F 8/10

(52) U.S. Cl. CPC G06F 8/423; G06F 8/10

(57) ABSTRACT

Systems, apparatus, articles of manufacture, and methods are disclosed to generate and/or utilize hints in tiered memories and storage. An example apparatus includes interface circuitry; instructions; and at least one programmable circuitry to be programmed by the instructions to: generate operational constraint hint information based on a pragma included in programming code; and insert a machine readable instruction into an application corresponding to the programming code based on the operational constraint hint information.

### RELATED APPLICATION(S)

This patent arises from a continuation of International Patent Application No. PCT/EP2025/081013, which was filed on Oct. 27, 2025. Priority to International Patent Application No. PCT/EP2025/081013 is claimed. International Patent Application No. PCT/EP2025/081013 is incorporated herein by reference in its entirety.

### STATEMENT REGARDING GOVERNMENT SUPPORT

The work leading to this invention has received funding from the European Union-Next Generation, Important Projects of Common European Interest (IPCEI). In particular, this invention was made with government support under Grant UNICO-IPCEI-2023-001 funded by the European Union-Next Generation IPCEI.

### FIELD OF THE DISCLOSURE

This disclosure relates generally to computing devices and, more particularly, to methods and apparatus to generate and/or utilize hints in tiered memories and storage.

### BACKGROUND

Storage class memory (SCM) has emerged as a useful component in the memory hierarchy. SCM is a type of physical computer memory that combines dynamic random access memory, NAND flash memory, and a power source for data persistence. SCM is a non-volatile memory. Thus, the data stored in SCM is not lost if the storage system crashes or loses power. In some memory hierarchies, SCM is below latches, registers, static random access memory (SRAM), caches, and dynamic random access memory (DRAM) and is above NAND flash, hard disk drive (HDD) storage, and cold storage. SCM is faster, less costly, and has less capacity than NAND flash, HDD storage and cold storage. SCM is slower, more costly, and has more capacity than latches, registers, cache SRAM, and DRAM.

### BRIEF DESCRIPTION OF THE DRAWINGS

FIG. 1 is a block diagram of an example environment in which an example computing system operates to generate and/or utilize hints in tiered memories and storage.

FIG. 2 is a block diagram of an example implementation of the compiler-side hint generation circuitry of FIG. 1.

FIG. 3 is a block diagram of an example implementation of the platform-side hint generation circuitry of FIG. 1.

FIG. 4 is a block diagram of an example implementation of the persistent memory of FIG. 1.

FIG. 5 is a flowchart representative of example machine readable instructions and/or example operations that may be executed, instantiated, and/or performed by example programmable circuitry to implement the compiler-side hint generation circuitry of FIG. 2.

FIGS. 6A and 6B illustrate a flowchart representative of example machine readable instructions and/or example operations that may be executed, instantiated, and/or performed by example programmable circuitry to implement the platform-side hint generation circuitry of FIG. 3.

FIG. 7 is a flowchart representative of example machine readable instructions and/or example operations that may be executed, instantiated, and/or performed by example programmable circuitry to implement the persistent memory of FIG. 4.

FIG. 8 is a flowchart representative of example machine readable instructions and/or example operations that may be executed, instantiated, and/or performed by example programmable circuitry to implement the persistent memory of FIG. 4.

FIG. 9 is a flowchart representative of example machine readable instructions and/or example operations that may be executed, instantiated, and/or performed by example programmable circuitry to implement the persistent memory of FIG. 4.

FIG. 10 illustrates an example hardware arrangement of an example data center.

FIG. 11A illustrates an example arrangement of an example chip assembly of FIG. 10.

FIG. 11B illustrates an example arrangement of an example chip assembly of FIG. 10, adapted for high-performance computing applications.

FIG. 12 is a block diagram of an example processing platform including programmable circuitry structured to execute, instantiate, and/or perform the example machine readable instructions and/or perform the example operations of FIGS. 5-9 to implement one or more of the compiler-side hint generation circuitry, the platform-side hint generation circuitry, and/or the persistent memory of FIGS. 2-4.

FIG. 13 is a block diagram of an example implementation of the programmable circuitry of FIG. 12.

FIG. 14 is a block diagram of another example implementation of the programmable circuitry of FIG. 12.

FIG. 15 is a block diagram of an example software/firmware/instructions distribution platform (e.g., one or more servers) to distribute software, instructions, and/or firmware (e.g., corresponding to the example machine readable instructions of FIGS. 5-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

The following introduces examples of computer hardware for hint generation and/or utilization for wear-leveling, read bandwidth throttling, prefetching, etc. in tiered memories and storage operations, applicable in programmable architectures such as chiplet-based processors, System-on-chip (SoC) circuitry, System-in-Package (SiP) or System-on-Package (SoP) circuitry, and/or any other modular packaging implementations of programmable circuitry. The following hardware examples specifically provide hint generation and/or utilization for wear-leveling, read bandwidth throttling, prefetching, etc. in tiered memories and storage.

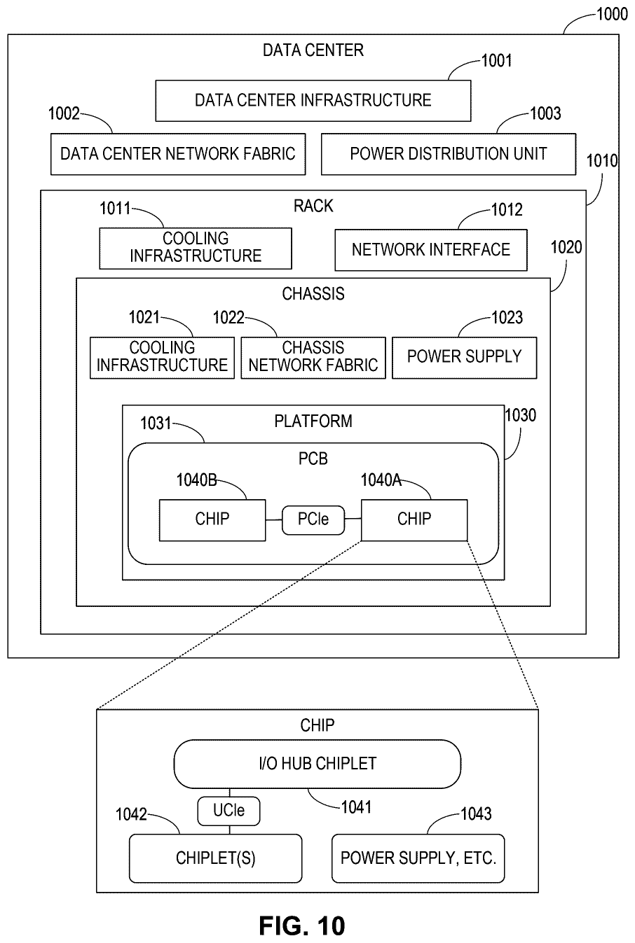

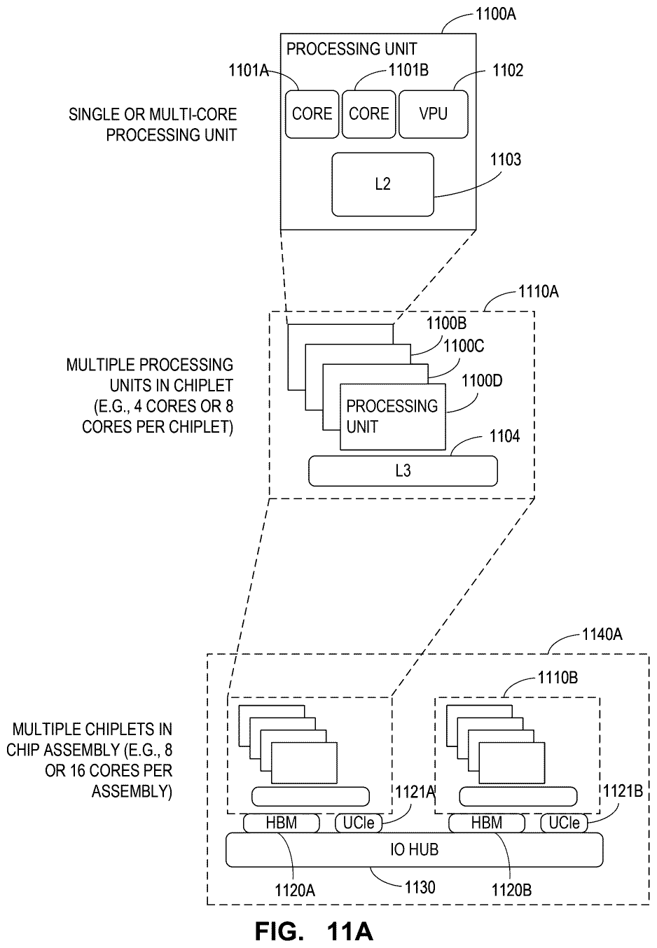

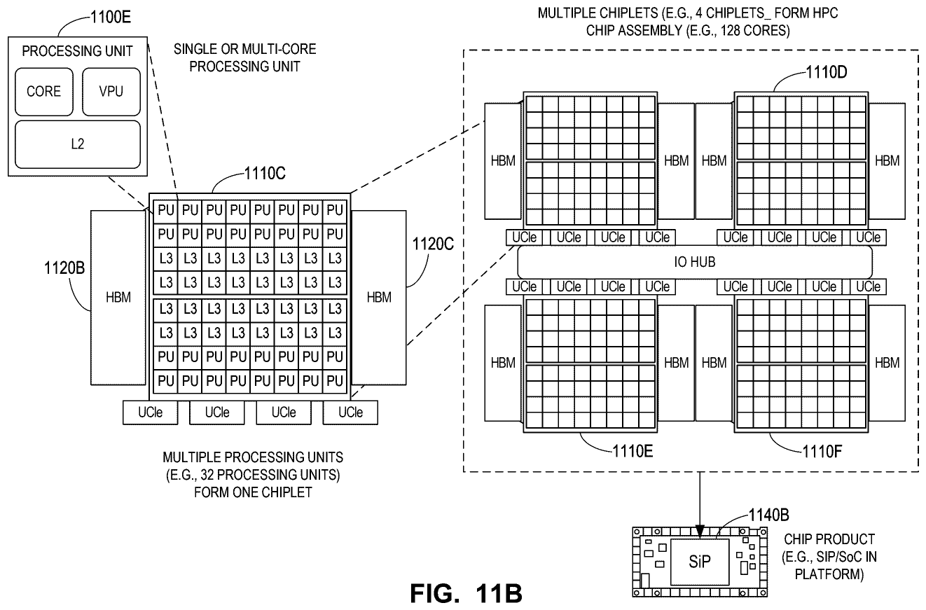

As used herein, a chiplet refers to any integrated circuit (IC) that has a modular structure designed to have one or more specified functionalities and to be combinable with one or more other chiplets on an interposer or other substrate in a package. Examples of chiplets are compute chiplets that include programmable circuitry (e.g., one or more processor circuits, such as one or more cores, etc.) and supporting circuitry (e.g., local memory, etc.) to provide computational functionality (e.g., to execute a host OS, applications, etc.), memory chiplets that include memory accessible to one or more other chiplets, communication chiplets that include communication interfaces (e.g., input/output hubs, networks, etc.) to enable other chiplets to communicate with each other and/or to other devices external to the package, etc. Example multi-tier management architectures provide a flexible management architecture that is multi-tiered to enable management of chiplet-based compute devices that include various combinations of chiplets from various manufacturers. Example implementations of chiplets are further described below in conjunction with FIGS. 10, 11A, and 11B.

SCM is a type of computer memory that retains data even after a system is powered off or crashes. SCM is also known as persistent memory and/or non-volatile memory. The materials used for SCM have limited endurance. For example, when devices are utilized, such as memory, processing cores, etc., heat is generated that can wear on the operation of the device. Some operations generate more heat than others, corresponding to faster wear of the components. For example, the life of an SCM is limited to a maximum number of write operations to a particular location of the SCM. Thus, if a particular memory location of SCM is written to more than the maximum number of write operations, the entire SCM can become unusable. This can be a problem in edge environments, for example, where an edge device or server may be difficult to get access to for replacing the SCM.

To extend the life of SCM, wear-leveling can be performed. Wear-leveling is a technique that attempts to evenly distribute operations (e.g., read operations, write operations, modify operations, erase operations, etc.) across the memory cells of a SCM. Wear-leveling attempts to avoid a particular memory cell from reaching the maximum number of write and/or erase operations that correspond to the end of use of the SCM. Wear-leveling recognizes that a small percentage of memory references (e.g., repeated access to the same memory cells) can cause significant pressure on memory media and seeks to instead enforce an even distribution of write pressure and/or erase pressure across the address space. Thus, wear-leveling ensures that a subset of memory locations is not used excessively and, thus, does not render the memory device unusable, or with less lifetime capacity than advertised. However, wear-leveling mechanics distribute non-linear traffic that arrives at the device, as opposed to reducing the amount of traffic itself.

Examples disclosed herein leverage memory hierarchies to control and contain pressure on operation condition leveling (e.g., such as wear-leveling) for storage class memories (SCM) in a memory subsystem. Some examples disclosed herein leverage read-write equivalences. The read-write equivalence impact on endurance of a memory cell may be 100:1. In other words, for a given location (e.g., memory cell(s), memory line, memory range), it takes one hundred read operations to have the same negative impact on endurance as a single write operation. Examples disclosed herein analyze program code to identify memory location(s) that correspond to larger write pressure (e.g., that will likely result in a large number of write operations to the identified memory location(s)). For example, a compiler, while compiling code, can identify portions of code that, when executed, cause a large number or write operations based on pragmas (e.g., directives), programmer comments, and/or based on the structure of the code itself (e.g., references to lock variables, locations that are written to in a loop, matrix operations that involve multiples writes, etc.). The compiler generates hints (e.g., also referred to as operational constraint hints or leveling hints) based on the identified portions of code (e.g., instructions) and provides the hints to the platform. The platform can transmit the instructions, code, etc. representative of the hints to the persistent memory and/or may develop additional hints (e.g., based on the compiler hints) during runtime, as further described below. The instructions can include data formatted from text or code. For example, the data can include one or more of text, symbols, code, characters, etc. that corresponds to the language of a programmer and/or information identified about a program. In some examples, the text that tells hardware that particular actions are likely to occur (e.g., a set of write accesses will occur to a specific small memory region). The instructions corresponding to a hint may include text that identifies the type of hint (e.g., WRITE_RANGE_HINT to identify that particular code will result in a set of write accesses to a range of memory) and/or parameters specific to the hint (e.g., Memory Range [A, B], estimated duration of access, etc.). Different types of hints illustrate different information, corresponding to different compositions. For example, for a WRITE_RANGE_HINT type hint, the hint may include information related to power optimization, life of the memory, carbon consumption, etc. However, for other types of hints (e.g., hints corresponding to read throttling, load balancing, etc.), the instructions representative of one or more hints may include additional and/or alternate information corresponding to the other types of hints.

Examples disclosed herein further leverage non-linearity in locations that are accessed. For example, a small percentage of memory address locations are responsible for wear-level optimization issues. Accordingly, examples disclosed herein monitor data movement throughout memory devices during runtime to identify certain memory ranges or memory lines that are accessed in patterns that imply frequent writebacks to the next level of a memory tier. As used herein, memory ranges, memory lines, address ranges, memory address ranges, and address lines are all used interchangeably to identify a second of memory. After data is evicted from a buffer and/or cache to memory media (e.g., memory cells) of SCM, the data stored in a buffer and/or cache of the memory hierarchy is written to the memory media (e.g., memory cells) of the SCM. Because an eviction of data from a buffer to another memory location corresponds to a write operation to persistent memory, examples disclosed herein may monitor a number of evictions of data (e.g., data removed from a buffer into persistent memory (e.g., SCM) or data moved from one level of a hierarchy to another lower level of the hierarchy). If the number of evictions for a particular memory address is above a threshold, the platform generates a hint that is provided to the persistent memory (e.g., SCM) for wear-leveling decisions. The persistent memory can leverage the hints to reduce the number of write operations and perform improved (e.g., more optimal/efficient) wear-leveling techniques. Accordingly, examples disclosed herein result in a longer lifespan of the SCM. Although some examples disclosed herein are described in the context of wear-leveling, examples disclosed herein can be utilized with any type of operation or constraint optimization. For example, one or more systems may utilize the hints described herein to optimize any performance that has a constraint, such as workload processing distribution, temperature distribution, prefetching, throttling, and/or other memory or processing optimization techniques.

Additionally or alternatively, examples disclosed herein can utilize operational constraint hints for other applications outside of wear-level optimizing techniques. For example, operational constraint hints may aid the persistent memory (e.g., SCM) in determining how to throttle read bandwidth for a read operations of an application due to thermal constraints, power constraints, and/or bandwidth constraints. Additionally, examples disclosed herein may utilize hints when making decisions related to prefetching data from persistent memory to buffer(s). For example, if the logic within persistent memory determines that the memory is slow or inefficient, the logic may start prefetching data based on the operational constraint hints from a compiler and/or an application. For example, the logic may decide to use a scratch pad (e.g., SRAM) as a small cache for the application. Additionally or alternatively, the logic may start prefetching data based on the current status of efficiency of the memory. Thus, examples disclosed herein can generate hints and perform leveling operations (e.g., wear-leveling, prefetching, throttling, etc.) based on the generated hints and/or telemetry data related to the persistent memory (e.g., SCM).

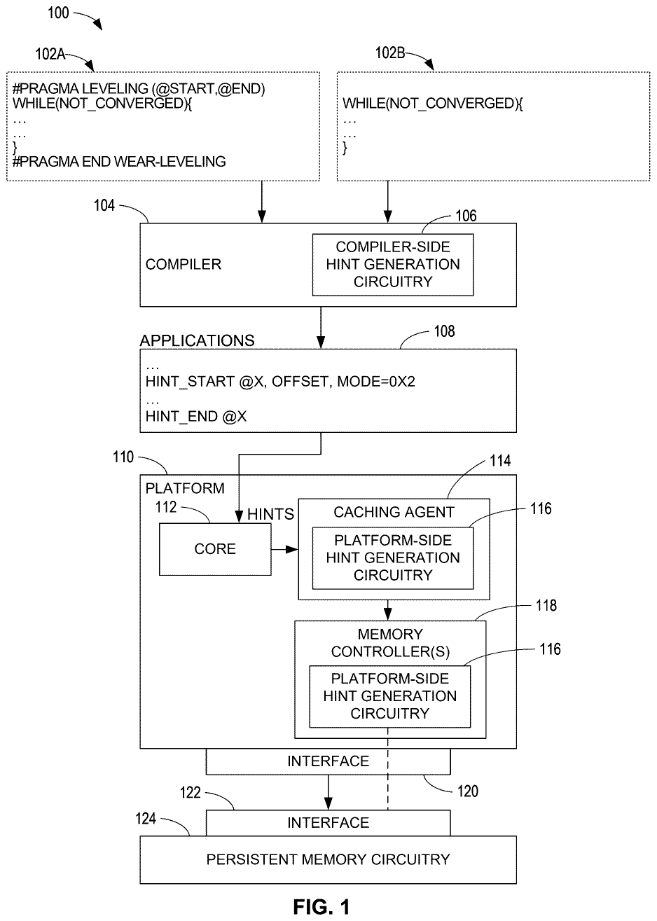

FIG. 1 is an example computing system 100 to generate and/or utilize hints (e.g., operational constraint hints) in tiered memories and storage. The computing system 100 includes example code 102A, 102B, an example compiler 104, example compiler-side hint generation circuitry 106, example applications 108, an example platform 110, an example core 112, an example caching agent 114, example platform-side hint generation circuitry 116, example memory controller(s) 118, example interface circuitries 120, 122, and an example persistent memory circuitry 124 such as SCM. Although the computing system 100 of FIG. 1 includes a single persistent memory, the computing system 100 may include any number or type(s) of memories.

The example code 102A, 102B of FIG. 1 is programming code that has been developed by a programmer. The programming code may be written in any high-level programming language. The programming code includes functions, methods, instructions, etc. for operation of the computing system 100. The example code 102a includes pragmas and/or programmer comments that identify that a particular memory location is likely to correspond to larger write, erase, or read pressure for a duration of time. A pragma is a compiler directive that provides additional information to the computer. Pragmas may be developed by a programmer to influence how the code is compiled without changing the language syntax itself. In the code 102a of this example, the pragma identifies where/when performing operation condition leveling, such as wear level optimization techniques, prefetching, operation throttling, etc. may be helpful and when to end operation condition leveling. In some examples, the pragma may specify whether the subsequent section of code corresponds to large or erase pressure, large read pressure, or both. The code 102b does not include pragmas but does include a loop. If the loop includes an instruction to read from, write to, or erase a memory location, the compiler may generate a hint while executing the loop, as further described below.

The example compiler 104 of FIG. 1 compiles the programming code (e.g., code 102a and/or code 102b). For example, the compiler 104 may convert the (e.g., high-level) programming code into machine code that is executed by core 112. The compiler 104 outputs the compiled programming code (e.g., the machine code corresponding to the programming code) to the platform 110 as the application 108. The compiler 104 includes the compiler-side hint generation circuitry 106. The compiler-side hint generation circuitry 106 generates hints that identify memory locations likely to result in a large number of writes, reads, and/or erases during a particular time. As further described below, the persistent memory circuitry 124 can use the hints (e.g., for wear level optimization techniques and/or prefetching purposes, to reduce the number of writes or erases to memory cells of the persistent memory circuitry 124 and, for read throttling purposes, the number of reads from memory cells of the persistent memory circuitry 124). Additionally, the platform 110 can use the hints during execution of the code to generate further hints by monitoring control of memory based on the hints, as further described below. The compiler-side hint generation circuitry 106 can generate the hints based on the pragmas, programmer comments, and/or the programming code itself. For example, the pragmas and/or programmer comments may identify sections of code, when executed, likely to result in a large number of read, write, erase operations to particular memory locations. Accordingly, the compiler-side hint generation circuitry 106 can generate the hints based on the memory locations corresponding to the pragmas and/or programmer comments. In some examples, the code may include instructions that are likely to result in a large number or reads, writes, and/or erases to particular memory locations. For example, the code may include loops, method/function calls, nested loops, lock variables, matrix operations, and/or any other code that may result in a large number of reads, writes, and/or erases to the same memory locations and/or group of memory addresses. Accordingly, the compiler-side hint generation circuitry 106 can generate hints based on the memory locations corresponding to the code.

The compiler 104 of FIG. 1 can insert instructions (e.g., machine readable instructions) representative of the hints generated by the compiler-side hint generation circuitry 106 into the application 108 to affect an operational constraint. The instructions may correspond to the location(s) where relevant. For example, if a hint is generated while a particular loop is executed, the compiler 104 can insert instructions representative of hint(s) at the start and/or the end of the particular loop. The instruction corresponding to a hint affects the operational constraints that the hint reflects. For example, if the operational constraint corresponds to a number of writes to a particular location of memory and the hint reflects the write heavy operation to the particular location of memory, the machine instructions reflecting the hint can affect (e.g., change) how the memory performs wear-leveling to avoid heavy write operations to the particular location of memory. The platform 110 can identify the details of when to utilize the hint(s) to the persistent memory circuitry 124 based on when the loop is be executed and/or when the loop execution is complete. An example instruction corresponding to a hint that an address range is likely to be accessed heavily in a specific mode can be of the form shown in the below-Instruction 1.

WLHINT_START @X, offset, units, MODE (Instruction 1)

In the above-Instruction 1, @X provides the baseline of the address range that the software stack (e.g., the core 112) is expected to start accessing frequently in a particular mode, offset provides the length of the actual memory range (which can be specified in different units), units provides the actual unit size of the offset (e.g., kilobytes, megabytes, etc.), and MODE provides whether the applications will access in read, write, or read/write mode. In some examples, the operation code may correspond to a different purpose of the hint. For example, the operation code for Instruction 1 is WLHINT indicative of an operational constraint hint. However, the operation code may be a PFHINT indicative of a prefetching hint, RTHINT indicative of a read throttling hint, or just a general HINT operation code. An example instruction corresponding to a hint that the active access to that memory range has ended can be of the form shown in the below-Instruction 2.

WLHINT_END @X (Instruction 2)

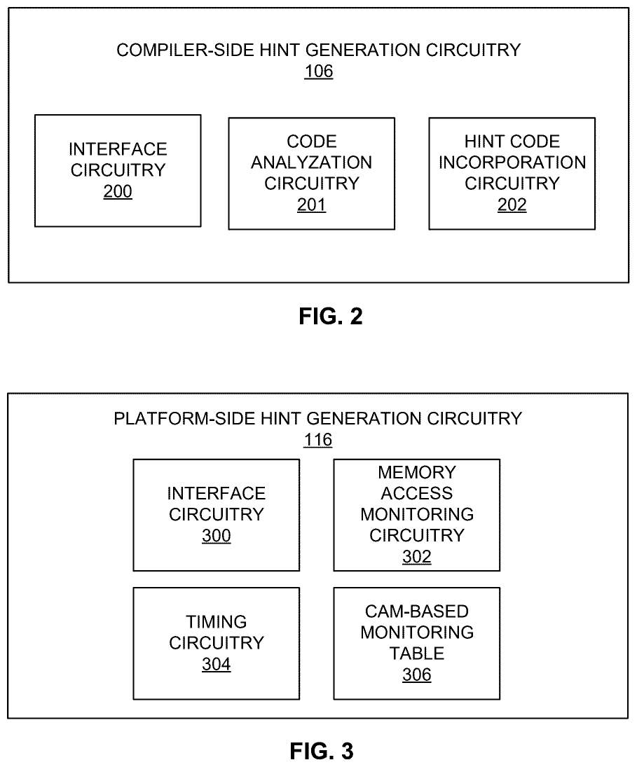

In the above-Instruction 2, @X provides the baseline of the address range that the software stack provided for the particular hint. The compiler provides the compiled applications 108 with the corresponding hints to the platform 110. As described above, the operation code for Instruction 2 may be generalized or may be different to indicate a different type of hint (e.g., prefetching, throttling, etc.). In some examples, the compiler-side hint generation circuitry 106 may determine sections of the code 102a, 102b that relate to a certain amount of bandwidth for a particular stream of access. The compiler-side hint generation circuitry 106 is further described below in conjunction with FIG. 2.

The platform 110 of FIG. 1 includes the core 112, the caching agent 114, the platform-side hint generation circuitry(ies) 116, the memory controller(s) 118, and the interface 120 (e.g., interface circuitry, a software interface, an API, etc.). The core 112 obtains the applications 108 from the compiler 104 and passes the compiler-side hints to the caching agent 114. Additionally, the core 112 can execute the application during runtime. In some examples, the compiler 104 can run on the core 112 in the platform 110.

The caching agent 114 of FIG. 1 manages caching of data and manages the coherency access to memory lines across the entire computing system 100 (e.g., in accordance with a cache coherency protocol). The memory controller(s) 118 acts as an interface between the platform 110 and the memory (e.g., the persistent memory circuitry 124). The memory controller 118 may be a single memory controller or multiple memory controllers (e.g., for different memories of the computing system 100). The caching agent 114 and/or the memory controller(s) 118 may include the platform-side hint generation circuitry 116.

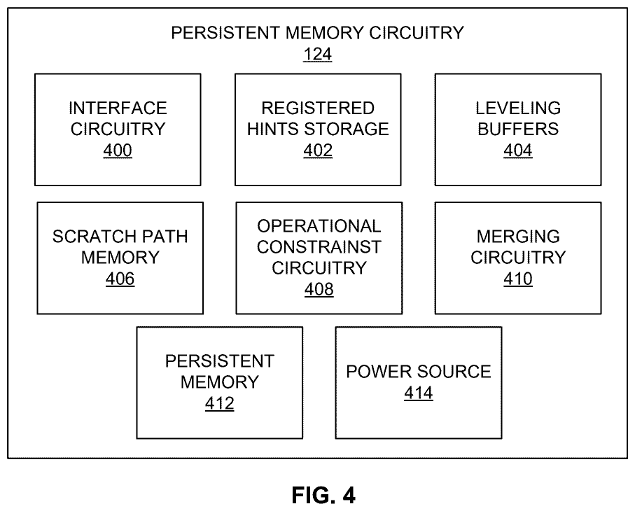

The platform-side hint generation circuitry 116 of FIG. 1 implements monitoring functionality to identify certain memory ranges or memory lines that are being accessed/written to in one or more pattern(s) that imply excessively frequent write backs to the next level of the memory tier. The platform-side hint generation circuitry 116 implements monitoring logic to monitor when (e.g., every time) a memory line is evicted from a buffer/cache to memory media, such as the SCM. The platform-side hint generation circuitry 116 stores the actual memory address(es) being evicted and determines which memory controller is responsible for managing the memory line (e.g., via a process address identifier). Because evictions correspond to write operations, tracking evictions corresponds to tracking write operations. The platform-side hint generation circuitry 116 monitors the eviction rate for the more frequently accesses memory address ranges. Also, the platform-side hint generation circuitry 116 includes a memory structure, such as a content-addressable memory (CAM)-based structure, that has N entries that host eviction information. The eviction information may include the number of evicts that have occurred for a particular memory range, the size of the monitored memory range (which can be configured or adaptively identified), and a current monitoring time interval (e.g., used with the number of evicts to compute the eviction frequency or rate). After a new eviction is identified by the platform-side hint generation circuitry 116, the platform-side hint generation circuitry 116 increments a count of evictions for the memory range. In some examples, the platform-side hint generation circuitry 116 may only increment a count of evictions that correspond to memory ranges that correspond to a compiler-generated hint. The platform-side hint generation circuitry 116 can generate a platform-side hint for a memory range based on the count for the memory range exceeding a threshold. Once the platform-side hint generation circuitry 116 generates a hint, the platform-side hint generation circuitry 116 determines the memory controller(s) that manages the memory range of the hint and transmits the hint to the corresponding memory controllers. The memory controller may be local to the platform or may be included in a different platform (e.g., managing other intermediate memories or caches). After a hint is obtained (e.g., a compiler-generated hint and/or a platform-generated hint) at the memory controller 118, the memory controller 118 transmits the hint(s) to the persistent memory circuitry 124 via the interface circuitry 120. The platform-side hint generation circuitry 116 may be implemented by an instruction set architecture (ISA) and/or an application programming interface (API). The platform-side hint generation circuitry 116 is further described below in conjunction with FIG. 3.

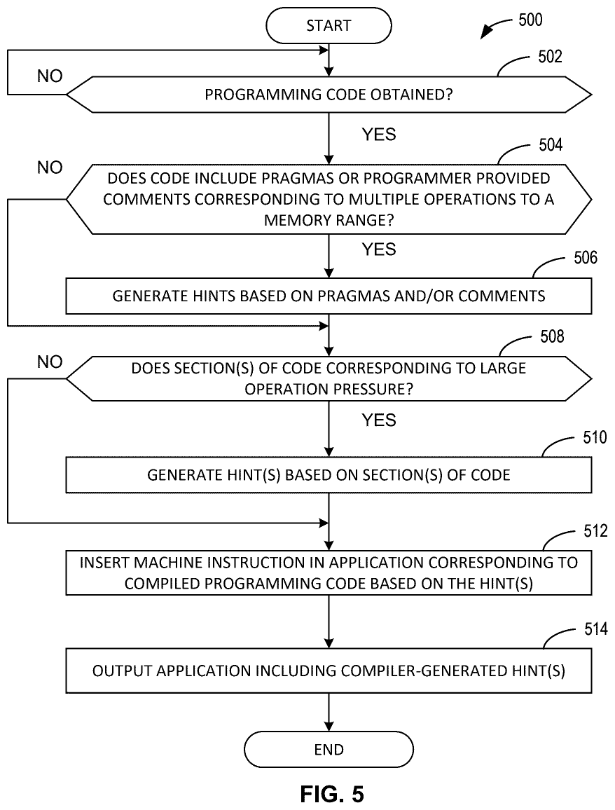

The interface 122 of the persistent memory circuitry 124 of FIG. 1 obtains hints (e.g., compiler generated hints and/or platform-generated hints) from the interface 120 of the platform 110. In some examples, the interface(s) 120, 122 are wireless interfaces to transmit code and/or hints to a separate device that implements the persistent memory circuitry 124, as further described below. The hints can be stored in a hints table of the persistent memory circuitry 124. The persistent memory circuitry 124 includes and/or is otherwise associated with leveling circuitry that performs leveling actions. For example, the leveling circuitry can perform operation condition leveling to extend the life of the memory cells of the persistent memory circuitry 124, prefetching to increase the efficiency and/or speed of application execution, and/or read operation throttling to prevent excess heat and/or bandwidth within the persistent memory. The leveling circuitry can translate hints into actions that enhance the lifetime of the persistent memory circuitry 124 (e.g., an SCM), increase the speed/efficiency of application execution, and/or prevent excess heat and/or bandwidth of the persistent memory circuitry 124. The leveling circuitry can buffer or cache data from memory lines that are pending to be flushed to persistent memory circuitry 124 (e.g., an SCM) in the buffer or cache based on a hint identifying a memory range that corresponds to those same memory lines. In some examples, the persistent memory circuitry 124 can generate telemetry hints based on telemetry data of the persistent memory. The telemetry data may include memory read bandwidth, memory write bandwidth, power consumption, constraint information, thermal information, error detection information, etc. In this manner, the persistent memory circuitry 124 can perform leveling decisions (e.g., wear-level optimizing, throttling, prefetching, etc.) based on both the operational constraint hints with the telemetry hints, as further described below. After a write operation arrives for a particular address and the data for the particular address is included in a buffer and/or cache, the leveling circuitry can track the write operations and consolidates the existing write to the same address that is hosted into the buffer for the same address, thereby reducing the number of writes to the persistent memory circuitry 124. Thus, when multiple write operations occur to the same memory address, instead of accessing data from the persistent memory, storing a copy of the data in the buffers, performing an operation on the data copy, and writing the manipulated data copy back to the persistent memory multiple times, resulting in multiple writes to the persistent memory, the data can be accessed once from the persistent memory, store a copy of the data in the buffers, perform multiple operations on the data copy, and write the manipulated data copy back to the persistent memory once. The persistent memory circuitry 124 is further described below in conjunction with FIG. 4. Although FIG. 1 is described in conjunction with hints being provided to the persistent memory circuitry 124, the hints may be provided to a controller that manages workloads, processing device usage, etc.

Although FIG. 1 illustrates hints that are generated within the same device (e.g., the computing system 100) as where the operation condition leveling techniques occur. The components of FIG. 1 may be implemented in separate devices. For example, the compiler 104 may be implemented in a first device, the platform 110 may be implemented in the first device or a second device, and the persistent memory circuitry may be implemented in the first device, the second device, or a third device. In such examples, the compiler 104 and/or the platform 110 can generate hints based on developed code and transmit the generated hints to a device (e.g., a device that implements the persistent memory circuitry 124) that implements the code. In some examples, an additional device can access the hints and provide the hints to the device that implements the code. In some examples, each device and/or other devices that analyze code can share generated hints and/or collected feedback to generate and/or modify already generated hints.

FIG. 2 is a block diagram of an example implementation of the compiler-side hint generation circuitry 106 of FIG. 1 to generate compiler-side operational constraint hints. The compiler-side hint generation circuitry 106 of FIG. 2 may be instantiated (e.g., creating an instance of, bring into being for any length of time, materialize, implement, etc.) by programmable circuitry. For example, the programmable circuitry may be implemented by a Central Processor Unit (CPU) and/or chiplet executing first instructions. Additionally or alternatively, the compiler-side hint generation circuitry 106 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. The compiler-side hint generation circuitry 106 of the example of FIG. 2 includes example interface circuitry 200, example code analyzation circuitry 201, and example hint code importation circuitry 202.

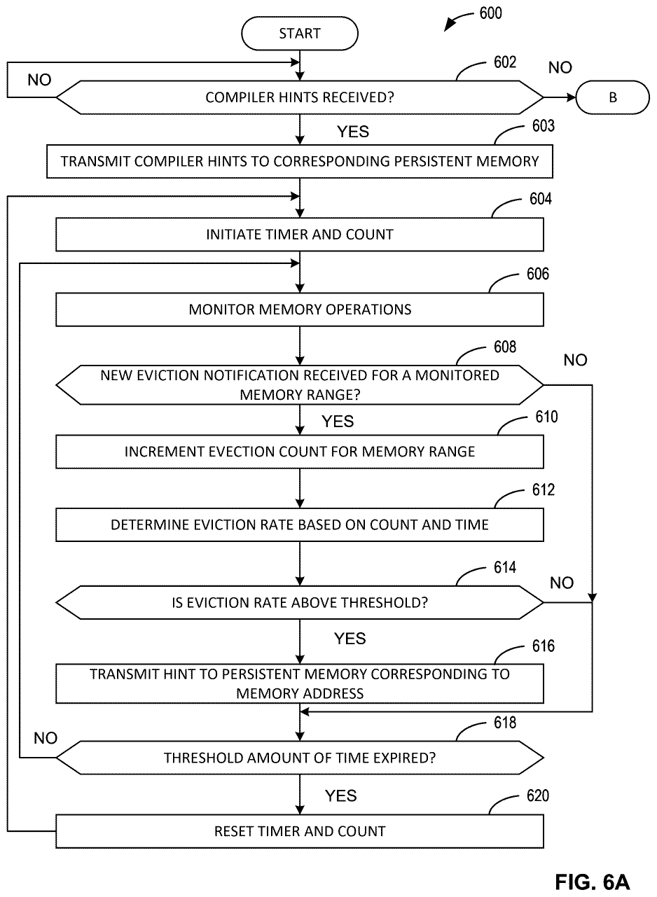

The example interface circuitry 200 of FIG. 2 obtains the programming code 102a, 102b. The interface circuitry 200 provides the programming code to the code analyzation circuitry 201. In some examples, the interface circuitry is instantiated by programmable circuitry executing interface instructions and/or configured to perform operations such as those represented by the flowchart(s) of FIG. 5.

The code analyzation circuitry 201 of FIG. 2 analyzes code (e.g., the code 102a, 102b) that was developed by a programmer, or other source (e.g., a remote function, an AI agent, a computing device, etc.) to identify programmer comments and/or pragmas. The programmer and/or other source can generate the programmer comments and/or pragmas locally using the platform 110 or remotely (using another computing device). After the programmer comments and/or pragmas are identified, the code analyzation circuitry 201 determines if the programmer comments and/or pragmas correspond to a potential large number of writes, erases, and/or reads to one or more memory ranges. For example, the programmer comments and/or pragmas may flag or hint at sections of code that the programmer believes will result in a potentially large number of writes, reads, and/or erases. Additionally, the code analyzation circuitry 201 of FIG. 3 may analyze the structure of the code (e.g., the code 102a, 102b) to identify sections of code that, when executed, may result in a large number of writes, reads, and/or erases to one or more particular memory ranges. For example, the code analyzation circuitry 201 may identify loops, nested loops, lock variables, matrix operations, and/or other sections of code that include write, read, and/or erase operations that may result in multiple writes, reads, and/or erases to one or more particular memory ranges. In some examples, the code analyzation circuitry 201 can identify section(s) of code that relate to a certain amount of bandwidth for a particular stream of access and generate hint(s) based on the identified section(s). For example, the code analyzation circuitry 201 can identify pragmas that identify certain bandwidth and/or may analyze the code to identify particular sections of the code that relate to a certain amount of bandwidth. In this manner, the persistent memory circuitry 124 can perform read throttling based on the generated hints, as further described below. After the code analyzation circuitry 201 has generated the hint(s) that identify memory ranges that may result in multiple write, read, and/or erase operations based on the code, the programmer notes, and/or pragmas, the code analyzation circuitry 201 outputs information related to the hint(s) to the hint code incorporation circuitry 202. In some examples, the code analyzation circuitry is instantiated by programmable circuitry executing code analyzation instructions and/or configured to perform operations such as those represented by the flowchart(s) of FIG. 5.

The hint code incorporation circuitry 202 incorporates the hint(s) into the compiled programming code (e.g., the application 108). The hint code incorporation circuitry 202 can insert the hint(s) and/or instruction(s) corresponding to the hint(s) before, during, or after the section of code that corresponds to the hint(s). For example, the hint code incorporation circuitry 202 can generate the above Instruction 1 and/or Instruction 2 to indicate the start and/or end of a hint that a memory range is likely to result in write, read, and/or erase operations. In some examples, the hint code incorporation circuitry is instantiated by programmable circuitry executing hint code incorporation instructions and/or configured to perform operations such as those represented by the flowchart(s) of FIG. 5.

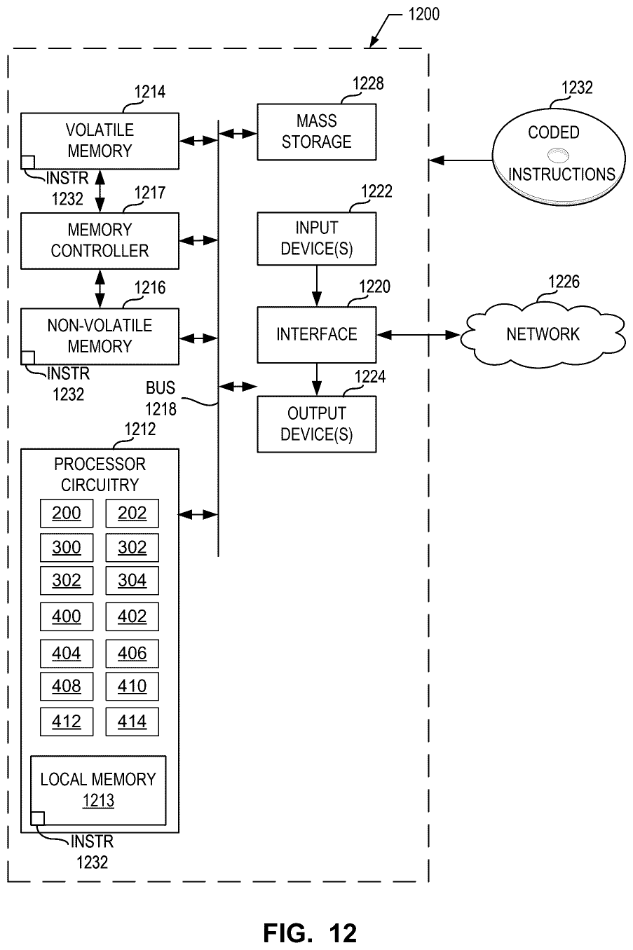

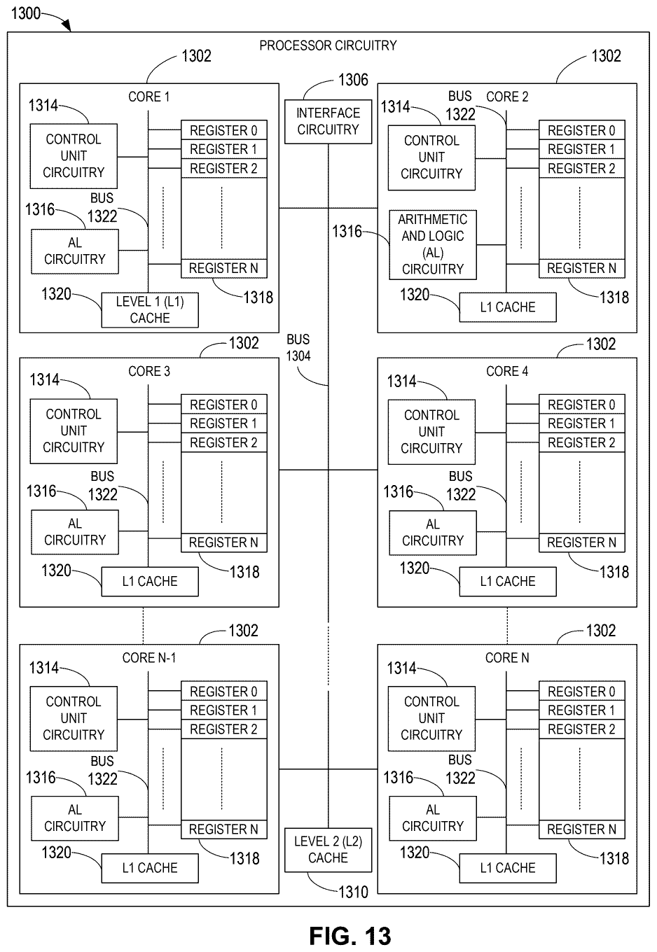

In some examples, the compiler-side hint generation circuitry 106 includes means for obtaining programming code, means for generating an operational constraint hint, and means for inserting a machine instruction. For example, the means for obtaining may be implemented by the interface circuitry 200, the means for generating may be implemented by the code analyzation circuitry 201, and the means for inserting may be implemented by the hint code incorporation circuitry 202. In some examples, the interface circuitry 200, the code analyzation circuitry 201, and/or the hint code incorporation circuitry 202 may be instantiated by programmable circuitry such as the example programmable circuitry 1012 of FIG. 10. For instance, the interface circuitry 200, the code analyzation circuitry 201, and/or the hint code incorporation circuitry 202 may be instantiated by the example microprocessor 1300 of FIG. 13 and/or the chiplet of FIGS. 11A and/or 11B executing machine executable instructions such as those implemented by at least blocks 502-514 of FIG. 5. In some examples, the interface circuitry 200, the code analyzation circuitry 201, and/or the hint code incorporation circuitry 202 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the interface circuitry 200, the code analyzation circuitry 201, and/or the hint code incorporation circuitry 202 may be instantiated by any other combination of hardware, software, and/or firmware. For example, the interface circuitry 200, the code analyzation circuitry 201, and/or the hint code incorporation circuitry 202 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for outputting also includes means for output an application to a platform and the means for generating may also include means for generating a second operational constraint hint.

FIG. 3 is a block diagram of an example implementation of the platform-side hint generation circuitry 116 of FIG. 1 to generate and/or transmit operational constraint hints to memory. The platform-side hint generation circuitry 116 of FIG. 3 may be instantiated (e.g., creating an instance of, bring into being for any length of time, materialize, implement, etc.) by programmable circuitry. For example, the programmable circuitry may be implemented by a Central Processor Unit (CPU) and/or one or more chiplet(s) executing first instructions. Additionally or alternatively, the platform-side hint generation circuitry 116 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The platform-side hint generation circuitry 116 of FIG. 3 includes example interface circuitry 300, example memory access monitoring circuitry 302, example timing circuitry 304, and an example CAM-based monitoring table 306.

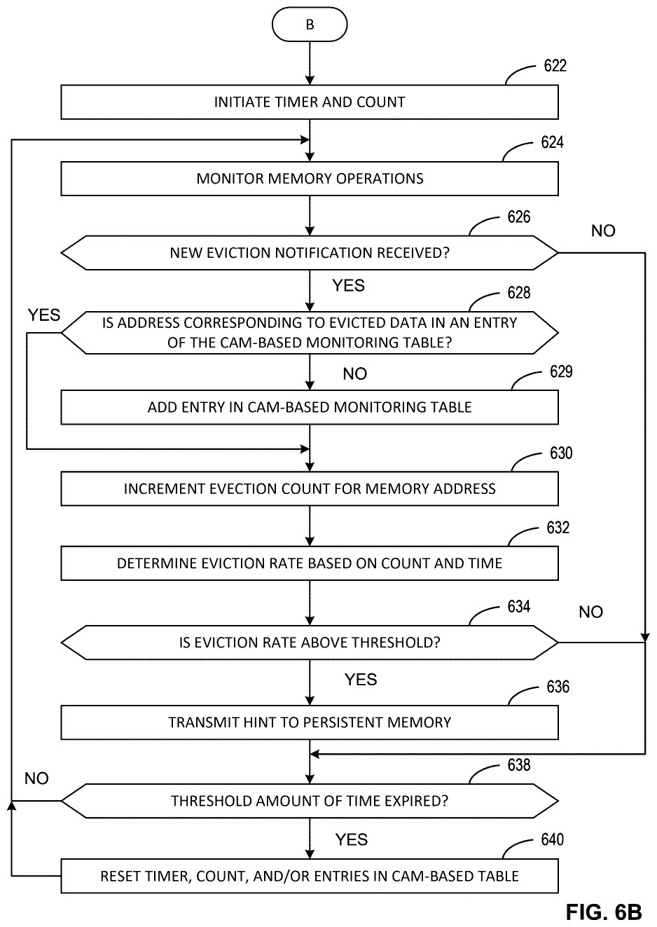

The interface circuitry 300 of FIG. 3 obtains the hints included in the applications 108 from the compiler 104 via the core 112. The interface circuitry 300 can transmit the obtained compiler-generated hints to one or the memory controller(s) 118 that manages the memory range identified in the hint. Additionally, the interface circuitry 300 transmits platform-generated hints to the memory controller(s) 118 that manages the memory range identified in the hint. In some examples, part or all of the interface circuitry 300 may be implemented by the interface 120 of FIG. 1. In some examples, the interface circuitry is instantiated by programmable circuitry executing interface instructions and/or configured to perform operations such as those represented by the flowchart(s) of FIGS. 6A and 6B.

The memory access monitoring circuitry 302 of FIG. 3 monitors operation of the memories of the computing system 100 (e.g., including the persistent memory circuitry 124). The memory access monitoring circuitry 302 monitors operation of the memories to identify evictions of data corresponding to memory ranges that occur during runtime of the application 108. The memory access monitoring circuitry 302 can track one or more (or all) memory ranges, and increment a count whenever an eviction corresponding to the one or more memory ranges occurs. Memory ranges can be measured in any described increments (e.g., in lines, on a cell by cell basis, in blocks, etc.). After an eviction occurs, the memory access monitoring circuitry 302 determines the memory address being evicted and which memory controller controls the affected memory address(es) (e.g., via a process address ID). Additionally, the memory access monitoring circuitry 302 can determine an eviction rate for one or more memory ranges based on the number of evictions and a duration of time during which the number of evictions occurred. In some examples, the memory access monitoring circuitry 302 only increments eviction counts and track eviction rate for memory ranges identified in the compiler-generated hints. In such examples, the memory access monitoring circuitry 302 generates N entries in the CAM-based monitoring table 306 for the N hints from the compiler, where each entry corresponds to the memory range of each hint and each entry includes a number of evictions for a duration of time and an eviction rate for the memory range. The monitoring table is further described below. In some examples, the memory access monitoring circuitry 302 tracks evictions across all memory ranges. In such examples, the memory access monitoring circuitry 302 generates a new entry in the CAM-based monitoring table 308 for each new eviction that corresponds to a memory range not currently represented in the CAM-based monitoring table 308. If the CAM-based monitoring table 308 already includes an entry for the memory range, the memory access monitoring circuitry 320 increments the eviction count for the entry. Periodically, aperiodically, and/or based on a trigger, the memory access monitoring circuitry 302 resets the count and/or entries of the CAM-based monitoring table 306. In some examples, the CAM-based monitoring table 306 can be replaced with another memory architecture, such as a Ternary CAM (TCAM), a binary CAM (BCA), etc.

Additionally, after the number of evictions for one or more particular memory ranges reaches a threshold and/or the eviction frequency reaches a threshold, the memory access monitoring circuitry 320 generates platform-generated hint(s) for particular memory range(s). After a hint is generated and/or after a compiler-generated hint is obtained, the memory access monitoring circuitry 320 identifies the memory controller(s) 118 that manage the various memory lines that correspond to the memory range included in the hint(s). In some examples, there may be multiple memories and/or memory controllers that manage a particular memory line (e.g., in the case of interleaving). The memory access monitoring circuitry 320 causes the hint(s) to be passed to the corresponding memory controller(s) 118 via the interface circuitry 300. In some examples, the memory access monitoring circuitry is instantiated by programmable circuitry executing memory access monitoring instructions and/or configured to perform operations such as those represented by the flowchart(s) of FIGS. 6A and 6B.

The timing circuitry 304 of FIG. 3 tracks a user, manufacturer, and/or code defined amount of time for measuring evictions. As described above, the memory access monitoring circuitry 302 can calculate the eviction rate for a particular memory range based on the number of evictions within a duration of time. Accordingly, the timing circuitry 304 can track time so that the memory access monitoring circuitry 302 can determine the eviction rate. The timing circuitry 304 may reset based on a trigger from the memory access monitoring circuitry 302. For example, the memory access monitoring circuitry 302 may reset the timing circuitry to reset the tracking of eviction counts and/or eviction rate periodically, aperiodically, and/or based on a trigger. In some examples, the timing circuitry is instantiated by programmable circuitry executing timing instructions and/or configured to perform operations such as those represented by the flowchart(s) of FIGS. 6A and 6B.

The CAM-based monitoring table 306 of FIG. 3 is a table that includes entries that track the eviction counts corresponding to one or more memory ranges. As described above, the CAM-based monitoring table 306 may include entries based on the compiler-generated hints or may include entry for memory ranges that have had an eviction. Additionally, the memory access monitoring circuitry 320 can reset or erase the entries at various points in time. Each entry may include a memory line identifier, a count of evictions, and/or an eviction frequency. An example of such a table is shown below.

Monitoring Table

<@LINE, NUM_EVICTIONS, FREQ_ACCESS>
<0X34, 0X43, Bitstream/Binary>

In some examples, the CAM-based monitoring table circuitry is populated by programmable circuitry executing CAM-based monitoring table instructions and/or configured to perform operations such as those represented by the flowchart(s) of FIGS. 6A and 6B.

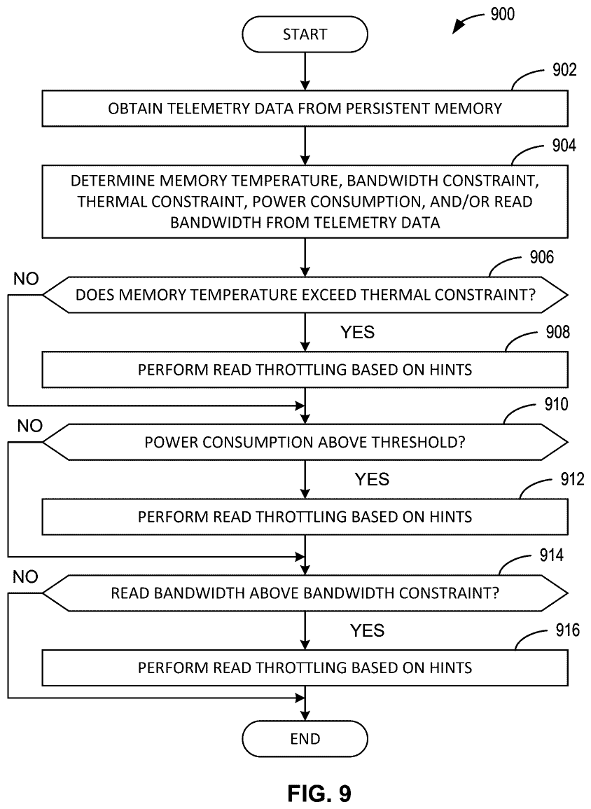

In some examples, the platform-side hint generation circuitry 116 includes means for obtaining an operational constraint hint, means for monitoring a number of evictions, means for tracking time, and means for storing entries. For example, the means for obtaining may be implemented by the interface circuitry 300, the means for monitoring may be implemented by the memory access monitoring circuitry 302, the means for tracking may be implemented by the timing circuitry 304, and the means for storing may be implemented by the CAM-based monitoring table 306. In some examples, the interface circuitry 300, the memory access monitoring circuitry 302, the timing circuitry 304, and/or the CAM-based monitoring table 306 may be instantiated by programmable circuitry such as the example programmable circuitry 1012 of FIG. 10. For instance, the interface circuitry 300, the memory access monitoring circuitry 302, the timing circuitry 304, and/or the CAM-based monitoring table 306 may be instantiated by the example microprocessor 1100 of FIG. 11 and/or the chiplet of FIGS. 9A and/or 9B executing machine executable instructions such as those implemented by at least blocks 602-640 of FIG. 6. In some examples, the interface circuitry 300, the memory access monitoring circuitry 302, the timing circuitry 304, and/or the CAM-based monitoring table 306 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the interface circuitry 300, the memory access monitoring circuitry 302, the timing circuitry 304, and/or the CAM-based monitoring table 306 may be instantiated by any other combination of hardware, software, and/or firmware. For example, the interface circuitry 300, the memory access monitoring circuitry 302, the timing circuitry 304, and/or the CAM-based monitoring table 306 may be implemented by at least one or more hardware circuits (e.g., processor circuitry, discrete and/or integrated analog and/or digital circuitry, an FPGA, an ASIC, an XPU, chiplet(s), core(s) a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for obtaining an operational constraint hint mean also include means for transmitting an operational constraint hint, the means for monitoring a number of evictions may also include means for generating an operational constraint hint and/or means for incrementing a count.

FIG. 4 is a block diagram of an example implementation of the persistent memory circuitry 124 of FIG. 1 to perform operation condition leveling (e.g., wear-level optimizing, read throttling, prefetching, etc.) based on operational constraint hints. The persistent memory circuitry 124 of FIG. 4 may be instantiated (e.g., creating an instance of, bring into being for any length of time, materialize, implement, etc.) by programmable circuitry. For example, the programmable circuitry may be implemented by a Central Processor Unit (CPU) and/or chiplet executing first instructions. Additionally or alternatively, the persistent memory circuitry 124 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers. The persistent memory circuitry 124 of FIG. 4 includes example interface circuitry 400, example registered hints storage 402, example leveling buffers 404, example scratchpad memory 406, example operational constraint circuitry 408, example merging circuitry 410, example persistent memory 412, and an example power source 414.

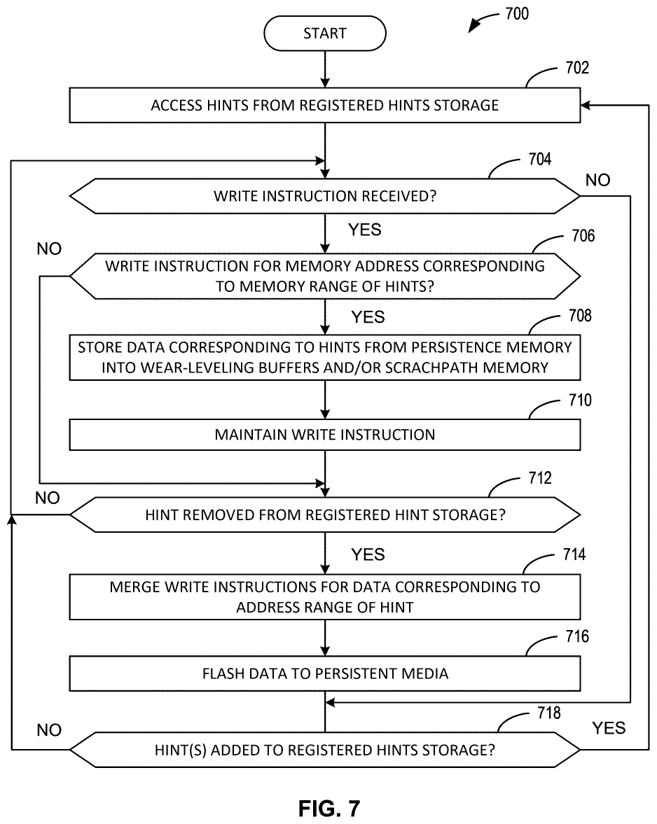

The interface circuitry 400 of FIG. 4 obtains hints from the platform 110. As further described above, the platform 110 can provide compiler-generated hints and/or platform-generated hints at points in time when a particular memory range is likely to exhibit multiple write, read, and/or erase operations. The interface circuitry 400 stores the received hints into the registered hints storage 402. In some examples, part or all of the interface circuitry 400 may be implemented by the interface 122 of FIG. 1. In some examples, the interface circuitry is instantiated by programmable circuitry executing interface instructions and/or configured to perform operations such as those represented by the flowchart(s) of FIG. 7.

The registered hints storage 402 of FIG. 4 stores the obtained hints. In some examples, the registered hints storage 402 stores the hints for a predefined amount of time. In some examples, the registered hints storage 402 rewrites the stored hints every time new hints are received. In this example, the registered hint storage 402 stores all the hints that correspond to memory ranges that currently (e.g., during particular portions of the runtime execution) are likely to result in multiple write, read, or erase operations. In other examples, each entry of the hints table includes a valid entry to identify if the hint(s) is currently valid or not. The leveling circuitry of this example can utilize the hints based on the hints being stored in the registered hints storage 402 or based on the validity indication in each entry. Each entry in the registered hints storage 402 may also include an address range for the memory range of the hint, and an access type (e.g., read, write, read/write, etc.). In some examples, the registered hints storage circuitry is instantiated by programmable circuitry executing registered hints storage instructions and/or configured to perform operations such as those represented by the flowchart(s) of FIG. 7.

The leveling buffers 404 of FIG. 4 are buffers that temporarily store data from the persistent memory 412 for particular memory lines while the data from the persistent memory 412 is to be manipulated. For example, while an application is being executed by the core 112, an instruction may ask for data from a memory line to be accessed. The data may be accessed to be manipulated, to be overwritten, to be erased etc. In such examples, the data from the persistent memory 412 is accessed and stored via the leveling buffers 404, not from/to the persistent memory 412. As such, accesses to the persistent memory 412 (e.g., SCM) and reduced. After execution of the instructions complete, the data can then be written back from the buffers 404 to the persistent memory 412. As described above, write operations to persistent memory 412 can reduce the life of the persistent memory circuitry 124. Accordingly, as further described below, the operational constraint circuitry 408 may keep the data in the leveling buffers 404 if there is a hint(s) indicating that multiple write operations are likely for the memory line. In this manner, the multiple operations can occur in the leveling buffers 404 instead of in the persistent memory 412 and then later, the data can be written back to the persistent memory 412. In this manner, the number of write operations to the persistent memory 412 from the leveling buffers 404 can be significantly reduced. For example, if 5 write operations occur within a short duration of time, the 5 write operations can happen within the leveling buffers 404 without changing the data in the persistent memory 412 (SCM). The result can be written back to the persistent memory 412 after the fifth write operation, as opposed to after each write operation.

The scratchpad memory 406 of FIG. 4 provides additional storage for operations on data accessed from the persistent memory 412. In general, the amount of space in the leveling buffers 404 is limited. Accordingly, the scratchpad memory 406 can provide larger storage to handle more data from more memory addresses or larger memory ranges for wear-level optimization, prefetched data, etc. Data may be stored as an entry in the scratchpad table. The entry may include an indication of the starting memory address for the data in the persistent memory circuitry 124, the memory range for the data, the location of the scratchpad base, and a validity indication. Such information is used for copying/flushing the data in the scratchpad memory 406 to the persistent memory 412. In some examples, the scratchpad memory 406 may be implemented by SRAM, cache, temporary memory, one or more buffers, on chip memory, or other appropriately sized memory.

The operational constraint circuitry 408 of FIG. 4 makes leveling decisions corresponding to when/how to prefetch data, when/how to read throttle, and/or when to write the data in the leveling buffers 404 and/or scratchpad memory 406 into the persistent memory 412 based on the instructions reflecting the hints from the compiler 106, the platform 110 and/or the persistent memory 412. Thus, the instructions reflecting the hints that have been compiled into an application affect the operational constraints by allowing the memory to adjust operation based on the hints. For example, the operational constraint circuitry 408 can provide priorities for data to stay in buffering or caching lines within the leveling buffers 404 and/or scratchpad memory 406 that are pending to be flushed to the persistent memory 412 that belong to an active range (e.g., a range of memory lines identified in the valid hints). After a write arrives at a particular memory line, the operational constraint circuitry 408 determines if the memory line belongs to an active range. If the operational constraint circuitry 408 determines that the write corresponds to an active memory line, the operational constraint circuitry 408 can hold the write instruction and the merging circuitry 410 can consolidate with other write operations for the same address that is hosted in the leveling buffers 404 and/or scratchpad memory 406 for the same address. In this manner, the writes to a same address occur at the non-persistent level until the hint(s) is no longer active and/or the operational constraint circuitry 408 decides to flush the data back to the memory address in the persistent memory 412. If the operational constraint circuitry 408 determines that the write operation does not correspond to an active range, the operational constraint circuitry 408 may push the write to the persistent memory 412 and/or store in one of the leveling buffers 404 and/or scratchpad memory 406 depending on the eviction policy and the status of the monitored ranges.

In some examples, the operational constraint circuitry 408 may prefetch data for an application based on the input from the application and/or based on the memory being slow. For example, the operational constraint circuitry 408 can identify memory access patterns based on monitoring of the persistent memory 412 and/or based on the operational constraint hints from the compiler 106 and/or the platform 110. The operational constraint circuitry 408 can prefetch data from the persistent memory 412 based on the memory access patterns. The operational constraint circuitry 408 can determine that the memory is slow by monitoring reads and or writes to/from the persistent memory 412 and estimate the speed based on timing information associated with the read and/or writes. If the operational constraint circuitry 408 determines that the memory is slow (e.g., below a threshold speed), the operational constraint circuitry 408 may enable prefetching based on memory access patterns and/or hints. In some examples, the operational constraint circuitry 408 may decide to perform prefetching based on the efficiency of the persistent memory 412. For example, the operational constraint circuitry 408 can determine the efficiency of the persistent memory 412 (e.g., higher bandwidth may result in less efficiency) based on a ratio of the bytes (e.g., read and/or written) to power consumption over a duration of time. The operational constraint circuitry 408 can determine the bytes by monitoring the persistent memory 412 and may obtain the power consumption as part of the telemetry data from the persistent memory 412. If memory efficiency is low, the operational constraint circuitry 408 may initiate prefetching.

In some examples, the operational constraint circuitry 408 may perform read throttling based on the operational constraint hints from the compiler 106 and/or platform 110 and/or the telemetry hints from the persistent memory 412. Read throttling is intentionally limiting the rate of data retrieval (e.g., read operations) from the persistent memory 412 to prevent overwhelming the system with too many requests. For example, the operational constraint circuitry 408 may determine that read throttling is needed when the temperature of the persistent memory 412 is too high (e.g., above a temperature threshold), the power consumption is too high (e.g., above a power consumption threshold), the read bandwidth is too high (e.g., corresponding to a bandwidth constraint), etc. As further described below, the persistent memory 412 may include thermal sensors that sense temperature and provide the temperature measurement(s) to the operational constraint circuitry 408 as part of telemetry data. Additionally, the persistent media 412 may provide the power consumption information, bandwidth, terminal constraint(s) (also referred to as temperature threshold(s)), and/or bandwidth constraint(s) (also referred to as bandwidth threshold(s)) of the persistent media 412 to the operational constraint circuitry 408 as part of the telemetry data. If the temperature measurement(s) exceeds the temperature constraint(s), the power consumption exceeds a power consumption threshold, and/or bandwidth exceeds the bandwidth constraints, the operational constraint circuitry 408 can enable read throttling and use the operational constraint hints to determine when and/or how to read throttle.

In some examples, the operational constraint circuitry 408 can perform other and/or additional operations based on the hints. For example, if an application corresponds to matrix operations and the matrix must fit into storage class memory level 2 (SCM-2) and corresponds to heavy writes (based on the hints), the operational constraint circuitry 408 may avoid replicating the write pressure on storage class memory level 1 (SCM-1) as well as the SCM-2 by skipping the SCM-1 layer from a caching perspective. In another example, if, based on the hints, the operational constraint circuitry 408 is aware that a particular percentage of references are responsible for most of the writes, then while considering eviction from a particular memory (e.g., DRAM), the operational constraint circuitry 408 can deprioritize dirty line eviction within an associated set for ranges below the references corresponding to the hints. In another example, the operational constraint circuitry 408 may pin certain write-heavy, but not performance critical, structures that are included for endurance considerations (as opposed to performance considerations) based on the hints. For example, the operational constraint circuitry 408 can pin (e.g., lock at in a particular memory level or structure) statistic-gathering structures that are constantly updated in DRAM for endurance considerations (in contract to for performance considerations, where these structures may have been evicted to SCM). In another example, in a feed-forward mechanism, if there are some dual inline memory modules (DIMMs) or other devices with higher overall wear levelling counts than others, the operational constraint circuitry 408 can decide to re-map at a virtual to physical memory level, to not place known endurance-heavy structure in address ranges that correspond to already-almost worn out DIMMs or devices. In some examples, the leveling circuitry is instantiated by programmable circuitry executing leveling instructions and/or configured to perform operations such as those represented by the flowchart(s) of FIG. 7.

In another example, the operational constraint circuitry 408 of FIG. 4 makes supply voltage/power decisions based on hints from the compiler 106, the platform 110 and/or the persistent memory 412. For example, the compiler-side hint generation circuitry 106 and/or the platform-side hint generation circuitry 116 may generate hints corresponding to sections of code that, when executed corresponds to processor intensive or memory intensive operations. In such an example, the operational constraint circuitry 408 can lower the power/voltage applied to processing components when a section of code corresponds to memory intensive operations and lower the power/voltage applied to the memory components when a section of code is executed that corresponds to processor intensive operations. In some examples, the operational constraint circuitry 408 can determine how much power adjust to make to the processing devices and/or the memory devices based on how processing and/or memory intensive the section of code is (e.g., based on the hints). In another example, the operational constraint circuitry 408 of FIG. 4 makes workload distribution decisions (e.g., across accelerators, across cores, across processing units, across chaplets, etc.) based on the hints from the compiler 106, the platform 110 and/or the persistent memory 412. For example, the compiler-side hint generation circuitry 106 and/or the platform-side hint generation circuitry 116 may generate hints corresponding to sections of code that the operational constraints circuitry 408 can leverage to make workload distribution decisions across the accelerators, cores, processing units, chiplets, etc. for workload execution efficiency. In another example, the operational constraint circuitry 408 of FIG. 4 makes workload distribution decisions (e.g., across accelerators, across cores, across processing units, across chaplets, etc.) based on temperature information to attempt to distribute heat across accelerators, cores, processing units, chiplets, etc. For example, an accelerator, a sensor, a core, a processing unit, a chiplet, etc. may provide temperature measurements (e.g., directly or via telemetry data) to the operational constraint circuitry 408. In such an example, the operational constraint circuitry 408 can distribute a workload in an attempt to distribute the workload for a more even temperature across devices in real time.

The merging circuitry 410 of FIG. 1 can store multiple operations (e.g., reads, adds, multiplies, etc.) to a particular memory line and merge the operations into one operation and/or perform all the operations within the leveling buffers 404 and/or scratchpad memory 406 before being flushed to the persistent memory 412. For example, if a particular operation is obtained for a memory address and later, before being flushed, an erase operation or an overwrite operation occurs to the same location, the merging circuitry 410 can discard the previous operation because the subsequent write overrides the previous operation. In some examples, the merging circuitry 410 can perform partial merges (e.g., based on a portion of the memory line being overwritten and a portion is left untouched by a subsequent operation to the memory line). In some examples, the merging circuitry is instantiated by programmable circuitry executing merging instructions and/or configured to perform operations such as those represented by the flowchart(s) of FIG. 7.

The persistent memory 412 of FIG. 4 includes the memory cells that store the data. Because the persistent memory 412 is persistent, the persistent memory 412 retains stored values even after a loss of power or crash. The persistent memory 412 may include sensors and/or other circuitry that can monitor characteristics of the persistent memory 412 and generate telemetry data corresponding to the state of the persistent memory 412. For example, the persistent memory 412 may include one or more sensors and/or circuits to determine temperature measurements, memory read bandwidth, memory write bandwidth, power consumption, errors detected, constraints of the persistent memory 412 (e.g., bandwidth constraint(s), thermal constraint(s), power constraint(s), etc.), and/or any other information related to the persistent memory 412. The persistent memory 412 provides the telemetry data (e.g., also referred to as telemetry hints) to the operational constraint circuitry 408. The persistent memory 412 stores data that can be identified based on memory address locations and/or memory lines. Data in the persistent memory 412 can be read and/or written to.

The power source 414 of FIG. 4 provides power during a crash or loss of power. The persistent memory 412 holds the stored data after a crash or loss of power. However, the registered hint storage 402, the leveling buffers 404, and/or the scratchpad memory 406 loses the stored data without power. Accordingly, in the event of a crash or a loss of power, the power source 414 provides power so that the operational constraint circuitry 408 can flush any necessary data in the registered hints storage 402, the leveling buffers 404, and/or the scratchpad memory 406 to the persistent memory 412 so that no data is lost.

In some examples, the persistent memory circuitry 124 includes means for obtaining operational constraint hints, means for storing operational constraint hints, means for storing data, means for performing operation condition leveling (e.g., wear-leveling, prefetching, read throttling, etc.), means for merging write operations, and/or means for providing power. For example, the means for obtaining may be implemented by the interface circuitry 400, the means for storing operational constraint hints may be implemented by the registered hints storage 402, the means for storing data may be implemented by one or more of the leveling buffers 404, the scratchpad memory 406, and/or the persistent memory 412, the means for merging may be implemented by the merging circuitry 410, and the means for providing power may be implemented by the power source 414. In some examples, the interface circuitry 400, the registered hints storage 402, the leveling buffers 404, the scratchpad memory 406, the operational constraint circuitry 408, the mering circuitry 410, the persistent memory 412, and/or the power source 414 may be instantiated by programmable circuitry such as the example programmable circuitry 1012 of FIG. 10. For instance, the interface circuitry 400, the registered hints storage 402, the leveling buffers 404, the scratchpad memory 406, the operational constraint circuitry 408, the mering circuitry 410, the persistent memory 412, and/or the power source 414 may be instantiated by the example microprocessor 1100 of FIG. 11 and/or the chiplet of FIGS. 9A and/or 9B executing machine executable instructions such as those implemented by at least blocks 702-718 of FIG. 7. In some examples, the interface circuitry 400, the registered hints storage 402, the leveling buffers 404, the scratchpad memory 406, the operational constraint circuitry 408, the mering circuitry 410, the persistent memory 412, and/or the power source 414 may be instantiated by hardware logic circuitry, which may be implemented by an ASIC, XPU, chiplet(s), core(s), or the FPGA circuitry 1200 of FIG. 12 configured and/or structured to perform operations corresponding to the machine readable instructions. Additionally or alternatively, the interface circuitry 300, the memory access monitoring circuitry 302, the timing circuitry 304, and/or the CAM-based monitoring table 306 may be instantiated by any other combination of hardware, software, and/or firmware. For example, the interface circuitry 400, the registered hints storage 402, the leveling buffers 404, the scratchpad memory 406, the operational constraint circuitry 408, the mering circuitry 410, the persistent memory 412, and/or the power source 414 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing one or more of the compiler-side hint generation circuitry 106, the platform-side hint generation circuitry 116, and/or the persistent memory circuitry 124 of FIG. 1 is illustrated in FIGS. 2, 3 and/or 4 one or more of the elements, processes, and/or devices illustrated in FIGS. 2, 3, and/or 4 may be combined, divided, re-arranged, omitted, eliminated, and/or implemented in any other way. Further, the code analyzation circuitry 201, the hint code incorporation circuitry 202, the interface circuitry 300, the memory access monitoring circuitry 302, the timing circuitry 304, the CAM-based monitoring table 306, the interface circuitry 400, the registered hints storage 402, the leveling buffers 404, the scratchpad memory 406, the operational constraint circuitry 408, the merging circuitry 410, the persistent memory 412, the power source 414, and/or, more generally, the example the compiler-side hint generation circuitry 106, the platform-side hint generation circuitry 116, and/or the persistent memory circuitry 124 of FIGS. 2, 3, and/or 4, may be implemented by hardware alone or by hardware in combination with software and/or firmware. Thus, for example, any of the code analyzation circuitry 201, the hint code incorporation circuitry 202, the interface circuitry 300, the memory access monitoring circuitry 302, the timing circuitry 304, the CAM-based monitoring table 306, the interface circuitry 400, the registered hints storage 402, the leveling buffers 404, the scratchpad memory 406, the operational constraint circuitry 408, the merging circuitry 410, the persistent memory 412, the power source 414, and/or, more generally, the example the compiler-side hint generation circuitry 106, the platform-side hint generation circuitry 116, and/or the persistent memory circuitry 124 of FIGS. 2, 3, and/or 4, could be implemented by programmable circuitry such as one or more chiplets, one or more processor cores, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs in combination with machine readable instructions (e.g., firmware or software). Further still, the example the compiler-side hint generation circuitry 106, the platform-side hint generation circuitry 116, and/or the persistent memory circuitry 124 of FIGS. 2, 3, and/or 4 may include one or more elements, processes, and/or devices in addition to, or instead of, those illustrated in FIGS. 2, 3, and/or 4, and/or may include more than one of any or all of the illustrated elements, processes and devices.

Flowchart(s) representative of example machine readable instructions, which may be executed by programmable circuitry to implement and/or instantiate the compiler-side hint generation circuitry 106, the platform-side hint generation circuitry 116, and/or the persistent memory circuitry 124 of FIGS. 2, 3, and/or 4 and/or representative of example operations which may be performed by programmable circuitry to implement and/or instantiate the compiler-side hint generation circuitry 106, the platform-side hint generation circuitry 116, and/or the persistent memory circuitry 124 of FIGS. 2, 3, and/or 4, are shown in FIGS. 5-9. The machine readable instructions may be one or more executable programs or portion(s) of one or more executable programs for execution by programmable circuitry such as the programmable circuitry 1212 shown in the example processor platform 1200 discussed below in connection with FIG. 12 and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-9, many other methods of implementing the compiler-side hint generation circuitry 106, the platform-side hint generation circuitry 116, and/or the persistent memory circuitry 124 of FIGS. 2, 3, and/or 4 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, chiplet(s), discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, a chiplet and/or array of chiplet(s), etc.)). As sed herein, programmable circuitry includes any type(s) of circuit that may be programmed to perform a desired function such as, for example, a CPU, a core, a chiplet, an array of chiplets, a GPU, a VPU and/or an FPGA. The programmable circuitry may include one or more CPUs, one or more cores, one or more chiplets, one or more GPUs, one or more VPUs, and/or one or more FPGAs located in the same package (e.g., the same integrated circuit (IC) package or in two or more separate housings), one or more CPUs, one or more cores, one or more chiplets, one or more GPUs, one or more VPUs, and/or one or more FPGAs in a single machine, multiple one or more CPUs, one or more cores, one or more chiplets, one or more GPUs, one or more VPUs, and/or one or more FPGAs distributed across multiple servers of a server rack, and/or multiple CPUs, cores, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 5-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a SCM, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to generate compiler-generated operational constraint hints. The example machine-readable instructions and/or the example operations 500 of FIG. 5 begin at block 502, at which the code analyzation circuitry 201 determines if programming code has been obtained via the interface circuitry 200.

If the code analyzation circuitry 201 determines that the programming code has not been obtained (block 502: NO), control returns to block 502 until programming code has been obtained. If the code analyzation circuitry 201 determines that the programming code has been obtained (block 502: YES), the code analyzation circuitry 201 determines if the code includes pragmas or programmer-provided comments corresponding to multiple operations (e.g., read, erase, and/or write) to a memory range (block 504). As further described above, the programmer can provide pragmas and/or comments that identify particular memory ranges that are likely to be written to, read from, and/or erased often for a duration of time. The identification of the memory ranges may be explicit or implicit. For example, a comment may state that a particular section of code may be executed often. In such an example, the code analyzation circuitry 201 can identify if the particular section includes read, write, erase and/or other manipulate operations to one or more memory ranges.

If the code analyzation circuitry 201 determines that the code does not include pragmas or programmer provided comments (block 504: NO), control continues to block 508. If the code analyzation circuitry determines that the code includes pragmas or programmer provided comments (block 504: YES), the code analyzation circuitry 201 generates hints based on the pragmas and/or comments (block 506). The hint(s) indicates that for a particular section of the code, multiple writes, erases, and/or reads are likely to occur for one or more memory ranges. At block 508, the code analyzation circuitry 201 determines if there are section(s) of the code corresponding to large operation pressure (e.g., read pressure, write pressure, erase pressure) based on the structure of the programming code. For example, the code analyzation circuitry 201 can look for instructions, loops, functions, methods, etc. that would likely result in high write, read, and/or erase pressure to one or more memory ranges when executed. For example, the code analyzation circuitry 201 may identify loops, nested loops, lock variables, matrix operations, and/or other sections of code include write, read, and/or erase operations that may result in multiple writes to one or more particular memory ranges.

If the code analyzation circuitry 201 determines that there are no section(s) of code corresponding to large operation pressure (block 508: NO), control continues to block 512. If the code analyzation circuitry 201 determines that there are section(s) of code corresponding to large operation pressure (block 508: YES), the code analyzation circuitry 201 generates hint(s) based on the identified section(s) of code corresponding to large operation pressure (block 510). At block 512, the hint code incorporation circuitry 202 inserts machine code instruction(s) into the application corresponding to the compiled programming code based on the hint(s). For example, the hint code incorporation circuitry 202 can generate the above Instruction 1 and/or Instruction 2 to indicate the start and/or end of a hint that a memory range likely to be written to multiple times. At block 514, the interface circuitry 200 outputs the application (e.g., the application 108) including the compiler-generated hints incorporated into the application to the platform 110.

FIGS. 6A and 6B include a flowchart representative of example machine readable instructions and/or example operations 600 that may be executed, instantiated, and/or performed by programmable circuitry to generate platform-generated operational constraint hint(s) and/or provide operational constraint hint(s) to the persistent memory circuitry 124 of FIG. 1. The example machine-readable instructions and/or the example operations 600 of FIG. 6 begin at block 602, at which the memory access monitoring circuitry 302 of FIG. 3 determines if compiler-generated hint(s) have been received from the compiler 104 via the interface circuitry 300.

If the memory access monitoring circuitry 302 determines that the compiler-generated hint(s) have not been received from the compiler 104 (block 602: NO), control continues to block 622 of FIG. 6B, as further described below. If the memory access monitoring circuitry 302 determines that the compiler-generated hint(s) have been received from the compiler 104 (block 602: YES), the interface circuitry 300 transmits the compiler hint(s) to the corresponding persistent memory (block 603). For example, the memory access monitoring circuitry 302 can, based on the section of the application corresponding to the hint(s) about to be executed, determine the memory controller(s) that manages the memory range(s) identified in the hint(s). After identification, the memory access monitoring circuitry 302 causes the interface circuitry 300 to transmit the hint(s) to the memory via the identified memory controller(s).

At block 604, the memory access monitoring circuitry 302 initiates the timing circuitry 304 to track a duration of time and initiates an eviction count for the memory ranges identified in the compiler-generated hint(s). For example, for each compiler-generated hint, the memory access monitoring circuitry 302 can generate an entry in the CAM-based monitoring table 306 identifying a memory range from the hint(s) with an initial eviction count of zero. At block 606, the memory access monitoring circuitry 302 monitors memory operation during runtime of the application.

At block 608, the memory access monitoring circuitry 302 determines if a new eviction notification has been received from one or of the memory controllers 118 for a monitored memory range (e.g., a memory range included in a hint(s) from the compiler and/or an entry in the CAM-based monitoring table 306 that corresponds to a monitored memory range). An eviction includes removing data stored in a first storage (e.g., a buffer or cache) and storing in (e.g., writing to) a second storage (e.g., persistent memory). If the memory access monitoring circuitry 302 determines that a new eviction notification has not been received (block 608: NO), control continues to block 618. If the memory access monitoring circuitry 302 determines that a new eviction notification has been received (block 608: YES), the memory access monitoring circuitry 302 increments the eviction count for the memory range in the entry stored in the CAM-based monitoring table 306 (block 610).

At block 612, the memory access monitoring circuitry 302 determines an eviction rate for the memory range based on the count of evictions and/or the time tracked by the timing circuitry 304. For example, the memory access monitoring circuitry 302 can divide the eviction count by the duration of time to determine the eviction rate for the memory range. At block 614, the memory access monitoring circuitry 302 determines whether the eviction rate is above a threshold. The threshold may be based on user and/or manufacturer preferences. In some examples, the memory access monitoring circuitry 302 may utilize the eviction count as opposed to the eviction rage. In such examples, the memory access monitoring circuitry 302 can compare the eviction count to a count threshold.

If the memory access monitoring circuitry 302 determines that the eviction rate is not above the threshold (block 614: NO), control continues to block 618. If the memory access monitoring circuitry 302 determines that the eviction rate is above the threshold (block 614: YES), the interface circuitry 300 transmits a platform-generated hint(s) that identifies the memory range with the high eviction rate to the persistent memory circuitry 124 (block 616). For example, the memory access monitoring circuitry 302 can determine the memory controller(s) that manages the memory range(s) with the high eviction rate. After identification, the memory access monitoring circuitry 302 causes the interface circuitry 300 to transmit the hint(s) to the memory via the identified memory controller(s).

At block 618, the memory access monitoring circuitry 302 determines if a threshold amount of time has expired. For example, the memory access monitoring circuitry 302 determines whether the time tracked by the timing circuitry 304 has reached a user and/or manufacturer defined threshold. If the memory access monitoring circuitry 302 determines that the threshold amount of time has not expired (block 618: NO), control returns to block 606 to continue to track evictions. If the memory access monitoring circuitry 302 determines that the threshold amount of time has expired (block 618: YES), the memory access monitoring circuitry 302 resets the timer and eviction count (block 620) and control returns to block 604. If additional compiler hint(s) are obtained at any time, the memory access monitoring circuitry 302 can add an entry to the CAM-based monitoring table 306 based on the additional compiler-generated hint(s). In some examples, the interface circuitry 300 may obtain an indication that a compiler hint has ended. In such examples, the memory access monitoring circuitry 302 may remove the corresponding entry from the CAM-based monitoring table 306.

At block 622 of FIG. 6B, the memory access monitoring circuitry 302 initiates the timing circuitry 304 to track a duration of time and initiates an eviction count for the memory range(s) identified in the compiler-generated hint(s). For example, for each compiler-generated hint, the memory access monitoring circuitry 302 can generate an entry in the CAM-based monitoring table 306 identifying a memory range from the hint with an initial eviction count of zero. At block 624, the memory access monitoring circuitry 302 monitors memory operation during runtime of the application.

At block 626, the memory access monitoring circuitry 302 determines if a new eviction notification has been received from one or of the memory controllers 118 for a monitored memory range (e.g., a memory range included in a hint from the compiler and/or an entry in the CAM-based monitoring table 306 that corresponds to a monitored memory range). An eviction includes removing data stored in a first storage (e.g., a buffer or cache) and storing the data in (e.g., writing the data to) a second storage (e.g., persistent memory). If the memory access monitoring circuitry 302 determines that a new eviction notification has not been received (block 262: NO), control continues to block 628. If the memory access monitoring circuitry 302 determines that a new eviction notification has been received (block 626: YES), the memory access monitoring circuitry 302 determines if the address corresponding to the evicted data is included in an entry of the CAM-based monitoring table 306 (block 628).

If the memory access monitoring circuitry 302 determines that there is an address corresponding to the evicted data included in an entry of the CAM-based monitoring table 305 (block 628: YES), control continues to block 630. If the memory access monitoring circuitry 302 determines that there is no address corresponding to the evicted data included in an entry of the CAM-based monitoring table 305 (block 628: NO), the memory access monitoring circuitry 302 adds an entry to the CAM-based monitoring table 306 that corresponds to the memory address of the eviction (block 629). At block 620, the memory access monitoring circuitry 302 increments the eviction count for the memory range in the entry stored in the CAM-based monitoring table 306.

At block 632, the memory access monitoring circuitry 302 determines an eviction rate for the memory range based on the count of evictions and/or the time tracked by the timing circuitry 304. For example, the memory access monitoring circuitry 302 can divide the eviction count by the duration of time to determine the eviction rate for the memory range. At block 634, the memory access monitoring circuitry 302 determines whether the eviction rate is above a threshold. The threshold may be based on user and/or manufacturer preferences. In some examples, the memory access monitoring circuitry 302 may utilize the eviction count as opposed to the eviction rage. In such examples, the memory access monitoring circuitry 302 can compare the eviction count to a count threshold.

If the memory access monitoring circuitry 302 determines that the eviction rate is not above the threshold (block 634: NO), control continues to block 638. If the memory access monitoring circuitry 302 determines that the eviction rate is above the threshold (block 634: YES), the interface circuitry 300 transmits a platform-generated hint(s) that identifies the memory range with the high eviction rate to the persistent memory circuitry 124 (block 636). For example, the memory access monitoring circuitry 302 can determine the memory controller(s) that manages the memory range(s) with the high eviction rate. After identification, the memory access monitoring circuitry 302 causes the interface circuitry 300 to transmit the hint(s) to the memory via the identified memory controller(s).

At block 638, the memory access monitoring circuitry 302 determines if a threshold amount of time has expired. For example, the memory access monitoring circuitry 302 determines whether the time tracked by the timing circuitry 304 has reached a user and/or manufacturer defined threshold. If the memory access monitoring circuitry 302 determines that the threshold amount of time has not expired (block 638: NO), control returns to block 626 to continue to track evictions. If the memory access monitoring circuitry 302 determines that the threshold amount of time has expired (block 638: YES), the memory access monitoring circuitry 302 resets the timer, eviction count, and/or entries in the CAM-based monitoring table 306 (block 640) and control returns to block 624.

FIG. 7 is a flowchart representative of example machine readable instructions and/or example operations 700 that may be executed, instantiated, and/or performed by programmable circuitry to perform operation condition leveling (e.g., wear-leveling) based on operational constraint hint(s). Although FIG. 7 is described in conjunction with wear-leveling, FIG. 7 can be adjusted to be described with any operation condition leveling, such as workload distribution to avoid uneven wear of processing devices and/or heat distribution.

The example machine-readable instructions and/or the example operations 700 of FIG. 7 begin at block 702, at which the interface circuitry 400 accesses hint(s) from the registered hints storage 402. As described above, hint(s) from the platform 110 are provided to the persistent memory circuitry 124 based on one or more memory ranges likely to correspond to multiple operations (e.g., read, write, and/or erase) for a duration of time. The registered hints storage 402 may be updated periodically, aperiodically, and/or based on hint(s) becoming available and/or no longer being relevant.

At block 704, the operational constraint circuitry 408 determines if write instructions have been received. The operational constraint circuitry 408 may also determine other instructions that result in a write instruction (e.g., an instruction to manipulate the data at a memory line). If the operational constraint circuitry 408 determines that a write instruction (or an instruction resulting in a write operation) has not been received (block 704: NO), control continues to block 718. If the operational constraint circuitry 408 determines that a write instruction has been received (block 704: YES), the operational constraint circuitry 408 determines if the write instructions for the memory address correspond to a memory range of a hint stored in the registered hints storage 402 (block 706).

If the operational constraint circuitry 408 determines that the write instructions for the memory address does not correspond to a memory range identified in the hint(s) (block 706: NO), control continues to block 712. If the operational constraint circuitry 408 determines that the write instruction for the memory address corresponds to a memory range identified in the hint(s) (block 706: YES), the operational constraint circuitry 408 store data corresponding to the hint(s) from the persistent memory circuitry 124 into the leveling buffers 404 and/or the scratchpad memory 406 (block 708). At block 710, the merging circuitry 410 maintains (e.g., stores) the write instruction. In this manner, the merging circuitry 410 can merge multiple write instructions to the same memory location before flushing to the persistent memory 412. In some example, the operational constraint circuitry 408 can perform the write instruction within the leveling buffers 404 and/or scratchpad memory 406, but not flush the result to the persistent memory 412 until a later points in time (e.g., after a threshold number of time, a threshold number of operations to the memory location, based on the hint(s) no longer being valid, etc.).

At block 712, the operational constraint circuitry 408 determines if a hint has been removed from the registered hint storage (e.g., because the hint is no longer valid). If the operational constraint circuitry 408 determines that the hint has not been removed (block 712: NO), control returns to block 704. If the operational constraint circuitry 408 determines that the hint has been removed (block 712: YES), the merging circuitry 410 merges the write instructions for the data corresponding to the address range of the removed hint (block 714). At block 716, the operational constraint circuitry 408 flushes (e.g., writes) the data from the leveling buffers 404 and/or scratchpad memory 406 that correspond to the removed hint to the persistent memory 412. Additionally or alternatively, write instructions for a particular memory range corresponding to a hint can be merged and/or flushed to persistent memory 412 after a threshold amount of time, after a threshold number of writes to the memory range, after a trigger, etc. At block 718, the operational constraint circuitry 408 determines if one or more hints have been added to the registered hints storage 402. If the operational constraint circuitry 408 determines that one or more hints have not been added to the registered hints storage (block 718: NO), control returns to block 704. If the operational constraint circuitry 408 determines that one or more hints have been added to the registered hints storage (block 718: YES), control returns to block 702.

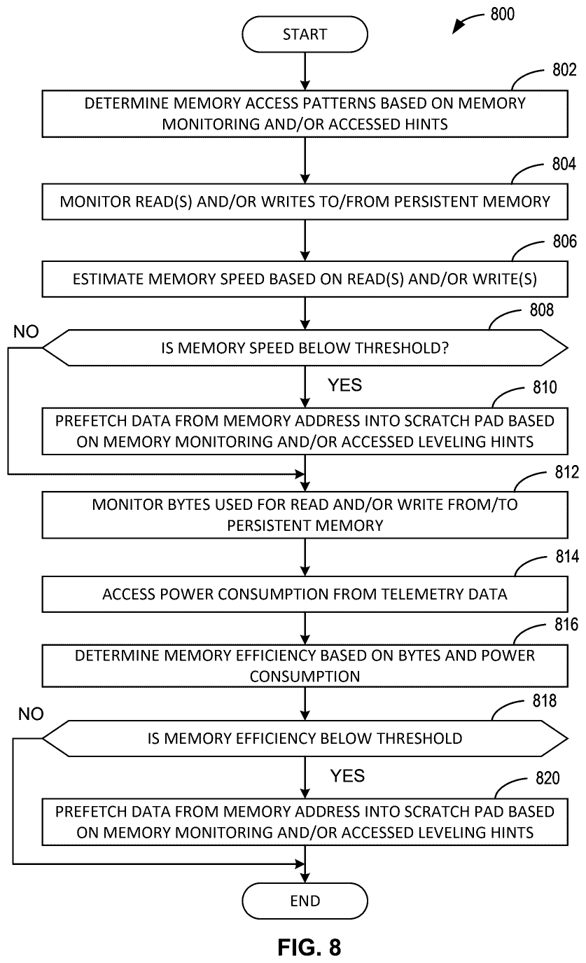

FIG. 8 is a flowchart representative of example machine readable instructions and/or example operations 800 that may be executed, instantiated, and/or performed by programmable circuitry to perform prefetching based on operational constraint hint(s) and/or telemetry data of the persistent memory 412. The example machine-readable instructions and/or the example operations 800 of FIG. 8 begin at block 802, at which the operational constraint circuitry 408 determines memory access patterns based on memory monitoring and/or accessed hints (e.g., levering hints stored in the registered hints storage 402). For example, the operational constraint circuitry 408 may identify memory access patterns by monitoring operation of the persistent memory 412 or can identify memory access patterns which have been generated by the compiler-side hint generation circuitry 106 or the platform-side hint generation circuitry 116 of FIGS. 1-3.

At block 804, the operational constraint circuitry 408 monitors reads from and/or writes to the persistent memory 412. At block 806, the operational constraint circuitry 408 estimates the memory speed of the persistent memory 412 based on the amount of time the read(s) and/or write(s) took to complete. At block 808, the operational constraint circuitry 408 determines if the memory speed is below a threshold. If the memory speed is below a threshold, the memory is slow and prefetching can increase the speed of the execution of an application. If the operational constraint circuitry 408 determines that the memory speed is not below a threshold (block 808: NO), control continues to block 812.

If the operational constraint circuitry 408 determines that the memory speed is below a threshold (block 808: YES), the operational constraint circuitry 408 prefetchers data from one or more memory addresses into the scratch path memory 406 based on the memory monitoring and/or accessed hints (block 810). For example, the operational constraint circuitry 408 can estimate data that is likely to be accessed from the persistent memory 412 in the near future based on the memory access patterns and/or based on hints that may identify that one or more memory addresses are likely to be accessed. The operational constraint circuitry 408 causes the estimated data from the persistent memory 412 to be accessed (e.g., prefetched) and stored into the scratch path memory 406. In this manner, when an access operation is obtained, the operational constraint circuitry 408 can access the data from the scratch path memory 406 instead of from the persistent memory 412, which is slower than the scratch path memory 406.

At block 812, the operational constraint circuitry 408 monitors the bytes used for a read and/or write from/to the persistent memory 412. At block 814, the operational constraint circuitry 408 accesses the power consumption information from the telemetry data for the read and/or write from/to the persistent memory 412. As described above, the persistent memory 412 provides telemetry data related to the persistent memory 412 to the operational constraint circuitry 408. At block 816, the operational constraint circuitry 408 determines the memory efficiency based on a ratio of the bytes to the power consumption. At block 818, the operational constraint circuitry 408 determines if the memory efficiency is below a threshold. If the memory efficiency is below a threshold, prefetching can increase the efficiency of the execution of an application. If the operational constraint circuitry 408 determines that the memory efficiency is not below a threshold (block 818: NO), the instructions end. If the operational constraint circuitry 408 determines that the memory efficiency is below a threshold (block 818: YES), the operational constraint circuitry 408 prefetchers data from one or more memory addresses into the scratch path memory 406 based on the memory monitoring and/or accessed hints (block 820).

FIG. 9 is a flowchart representative of example machine readable instructions and/or example operations 900 that may be executed, instantiated, and/or performed by programmable circuitry to perform read throttling based on operational constraint hint(s) and/or telemetry data of the persistent memory 412. Although FIG. 9 is described in conjunction with read throttling, FIG. 9 may be described in conjunction with other operations, such as workload distribution for a more even temperature distribution across cores, chiplets, processing devices, etc.

The example machine-readable instructions and/or the example operations 900 of FIG. 9 begin at block 902, at which the operational constraint circuitry 408 obtains telemetry data from the persistent memory 412. As described above, the telemetry data includes data related to the persistent memory 412. For example, the telemetry data may include memory read bandwidth, memory write bandwidth, power consumption, constraint information, thermal information, error detection information, etc.

At block 904, the operational constraint circuitry 408 processes the telemetry data to determine the temperature of the persistent memory 412, a bandwidth constraint for the persistent memory 412, a thermal constraint for the persistent memory 412, power consumption of the persistent memory 412, and/or a current read bandwidth of the persistent memory 412. At block 906, the operational constraint circuitry 408 determines if the memory temperature exceeds the thermal constraint. If the operational constraint circuitry 408 determines that the memory temperature does not exceed the thermal constraint (block 906: NO), the instructions continue to block 910.

If the operational constraint circuitry 408 determines that the memory temperature does exceed the thermal constraint (block 906: YES), the operational constraint circuitry 408 performs read throttling based on the hints (block 908). For example, the operational constraint circuitry 408 may identify portions of the application that require a lower read bandwidth based on the operational constraint hints generated by the compiler 106 and/or platform 110. The operational constraint circuitry 408 may enable read throttling where appropriate based on the read bandwidth included in a hint, when the hint is stored in the registered hints storage 402.

At block 910, the operational constraint circuitry 408 determines if the power consumption is above a threshold. The threshold may be based on user and/or manufacturer preferences. If the operational constraint circuitry 408 determines that the power consumption does not exceed the threshold (block 910: NO), the instructions continue to block 914. If the operational constraint circuitry 408 determines that the power consumption exceeds the threshold (block 910: YES), the operational constraint circuitry 408 performs read throttling based on the hints (block 912).

At block 914, the operational constraint circuitry 408 determines if the read bandwidth is above the bandwidth constraint. The threshold may be based on user and/or manufacturer preferences. If the operational constraint circuitry 408 determines that the read bandwidth does not exceed the bandwidth constraint (block 914: NO), the instructions end. If the operational constraint circuitry 408 determines that the read bandwidth exceeds the bandwidth constraint (block 914: YES), the operational constraint circuitry 408 performs read throttling based on the hints (block 916) and the instructions end.

FIGS. 10, 11A, 11B, and 12 include example computing architectures in which any of the techniques and configurations above may be implemented.

FIG. 10 illustrates an example hardware arrangement of an example data center 1000 used to provide multiple examples or instances of a computing system (e.g., the programmable circuitry platform 1200, described below), with each example of the computing system identified as a respective platform (e.g., the platform 1030, described below). The data center 1000 includes example data center infrastructure 1001, an example data center network fabric 1002, and an example power distribution unit 1003 to support multiple racks of compute platforms, with a single instance of an example rack 1010 depicted. The data center infrastructure 1001 may provide physical components that host the compute platform hardware, storage components, and/or networking equipment. The data center network fabric 1002 may include switches and/or networking components to support data flows among various compute platforms and storage devices throughout the data center. The power distribution unit 1003 may include components to distribute and/or control power among the various compute platforms, networking, and storage devices.

The rack 1010 of FIG. 10 includes, but is not limited to, example cooling infrastructure 1011, an example network interface 1012, and/or other related physical components to support discrete instances of multiple chassis. The rack 1010 provides power, connectivity, and/or cooling to each of the multiple chassis in a single rack, with a single instance of a chassis 1020 in the example of FIG. 10. The chassis 1020 includes, but is not limited to, example cooling infrastructure 1021, an example chassis network fabric 1022, and an example power supply 1023, which provides cooling, network connectivity, and/or power to multiple platforms within the chassis. Although a single instance of an example platform 1030 is illustrated in FIG. 10, in some examples, a common data center rack configuration may include dozens of chassis, with each chassis to support a number of platforms depending on the physical size of the platform hardware and/or supporting equipment.

The platform 1030 of FIG. 10 may be referred to as a server or node, depending on the use case for the platform 1030 and the data center 1000. The platform 1030 includes but is not limited to examples of a discrete computing system hosted on a single board. In FIG. 10, the platform 1030 is illustrated as hosting a first example chip assembly 1040A and a second example chip assembly 1040B on a first board provided by a printed circuitry board (PCB) or other platform board, shown as an example PCB 1031. In some examples, the platform 1030 may include only one chip package, whereas the PCB 1031 includes interconnection of multiple chip assemblies via an interface (e.g., a peripheral component interconnect express (PCIe) interface). Additional chip packages and components may also be hosted on the PCB 1031.

Some examples of the chip assembly 1040A, 1040B of FIG. 10 may be termed as a System-on-Chip (SoC) package, as modular chiplets that perform different functions are integrated into a single package—even though this chip package is composed of multiple dies unlike a traditional SoC design that uses a single die. Other examples of the chip assembly 1040A, 1040B may include a System-on-Package (SoP), System-in-a-Package (SiP), or other single chip packages. Various combinations of 2 dimension (D), 2.5D, and/or 3D packaging technologies may be used to manufacture and/or assemble the chip package and its underlying structure. Additionally, different manufacturing processes may be used to provide chiplets and components from different process nodes (e.g., semiconductor fabrication systems).

The first chip assembly 1040A and the second chip assembly 1040B of FIG. 10 are packages that include multiple chiplets and/or dies for respective functions, such as separate chiplets for processing (e.g., central processing unit (CPU) or graphical processing unit (GPU) chiplets), memory (e.g., cache or high-bandwidth memory chiplets), input/output (I/O) (e.g., I/O chiplets), acceleration (e.g., artificial intelligence (AI)/machine learning (ML) acceleration chiplets), signal processing (e.g., audio or video processing chiplets), etc. The close-up of chip assembly 1040A of FIG. 10 includes a I/O Hub chiplet 1041, chiplets 1042, and a power supply 1043. These components may be hosted on an interposer that is designed to connect multiple dies and/or components within a single semiconductor package (e.g., chip package). In some examples, the chiplets 1042 may be manufactured and/or sourced separately and later assembled into the chip package to create the chip assembly 1040A. Various connections may be provided among the chiplets 1042, such as with the use of Universal Chiplet Interconnect Express (UCIe) interfaces and communications, and/or between chiplets and on-chip memory (e.g., high-bandwidth memory (HBM)) using HBM3 (JEDEC), Universal Memory Interface (UMI), or other memory interfaces.

FIG. 11A illustrates an example arrangement of an example chip assembly 1140A (e.g., a multi-processing core example of the first chip assembly 1040A or the second chip assembly 1040B of FIG. 10), with expanded views of the chiplets and processing units included herein. In FIG. 11A the chip assembly 1140A, which may constitute a SoC, SoP, SiP, and/or other type of chip package, includes chiplets such as an example chiplet 1110A, an example chiplet 1110B, etc. and associated on-package memory (e.g., high-speed memory) such as 3D-stacked, High Bandwidth Memory (HBM) instances (shown as an example HBM 1120A, an example HBM 1120B, interfaces (e.g., UCIe interfaces) shown as an example UCIe 1121A, an example UCIe 1121B, and an example I/O hub 1130 (e.g., which may be implemented by a I/O chiplet). Other hardware elements of a chip package are not included for simplicity. Although the examples disclosed herein are described in conjunction with UCLe interfaces, one or more of the interfaces may be device-to-device (Dev2Dev) interfaces (e.g., CXLI, peripheral component interconnect express (PCIE)), die to die (D2D) interfaces (e.g., NVLINK), chiplet to chiplet (Ch2Ch) interfaces (e.g., universal chiplet interconnected express (UCIe)), core to core (C2C) interfaces (e.g., using coherency protocols), etc.

The chiplets 1110A, 1110B of FIG. 11A include multiple processing units and the example processing units 1100A, 1100B, 1100C, 1100D include one or multiple cores, respectively. For example, the chiplet 1110A of FIG. 11A includes four processing units (the processing units 1100A, 1100B, 1100C, 1100D) and an example Level 3 (L3) cache 1104. The processing units 1100A, 1100B, 1100C, 1100D may include one or multiple processing cores, one or multiple caches, other processing units and/or passive and/or active elements. For example, processing unit 1100A includes two cores (an example core 1101A and an example core 1101B), vector processing unit 1102, and an example level 2 (L2) cache 1103. Accordingly, a single-core processing unit can provide four cores per chiplet and eight total cores in a two-chiplet chip assembly, whereas a dual-core processing unit can provide eight cores per chiplet and sixteen total cores in a two-chiplet chip assembly. However, examples disclosed herein may correspond to other permutations.

FIG. 11B is an example arrangement of an example chip assembly 1140B (e.g., a multi-chiplet high-performance computing (HPC) example of chip assembly 1040A, 1040B), adapted for HPC applications (e.g., parallel processing operations involving thousands, millions, or more of processors and/or cores operating simultaneously). The example chip assembly 1140B illustrates placement as a SiP, SoC, and/or other package onto a platform board (e.g., the PCB 1031 of FIG. 10). The platform board may be in a data center (e.g., the data center 1000 of FIG. 10) or in a standalone deployment setting (e.g., in a standalone computer system, mobile computing device, autonomous device, etc.).

The chip assembly 1140B of FIG. 11B is composed of multiple chiplets, shown with four chiplets, including example chiplets 1110C, 1110D, 1110E, 1110F. The chiplets 1110C, 1110D, 1110E, 1110F include multiple processing units, such as thirty-two processing units with a corresponding level 3 (L3) cache for each processing unit. The processing units may include one or multiple cores, such as an example single-core processing unit 1100E shown as part of the chiplet 1110C. The chip assembly 1140B also includes corresponding memory resources, such as HBM elements corresponding to respective banks of processing units (e.g., HBM 1120B and HBM 1120C corresponding respective sets of processing units of chiplet 1110C), UCIe interfaces, and/or an IO Hub.

The chip assembly and related products or devices described herein may be configured in a variety of computing system examples. Such examples include non-transitory machine-readable media storing machine-readable instructions and one or more processors coupled to the memory, such that executing the machine-readable instructions configure one or more of the processors and/or implementing hardware (e.g., the processing unit 1100, the chiplet 1110, the chip 1040, and/or the platform 1030 of FIGS. 10, 11A, and/or 11B) to perform operations described above for electronic systems or devices (e.g., to generate and/or utilize hints in tiered memories and storage, etc.). It should be further understood that software, including one or more machine readable instructions, that facilitate processing and operations as described above may be distributed, installed, or otherwise provided to networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

FIG. 12 is a block diagram of an example programmable circuitry platform 1200 structured to execute and/or instantiate the example machine-readable instructions and/or the example operations of FIGS. 5-9 to implement the compiler-side hint generation circuitry 126, the platform-side hint generation circuitry 136, and/or the persistent memory 144 of FIGS. 2, 3, and/or 4. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, and/or microcontrollers from any desired family or manufacturer. In some examples, the programmable circuitry 1212 can be implemented by reduced instruction set computer (RISC)-V architecture and/or a chiplet (e.g., the chiplet assemblies 1040A, 1040B, 1140A, 1140B of FIGS. 11, 12A and/or 12B). The programmable circuitry 1212 may be implemented by one or more semiconductor based (e.g., silicon based) devices. In this example, the programmable circuitry 1212 implements the code analyzation circuitry 201, the hint code incorporation circuitry 202, the interface circuitry 300, the memory access monitoring circuitry 302, the timing circuitry 304, the CAM-based monitoring table 306, the interface circuitry 400, the registered hints storage 402, the leveling buffers 404, the scratchpad memory 406, the operational constraint circuitry 408, the merging circuitry 410, the persistent memory 412, the power source 414 of FIGS. 2-4.

In some examples, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of first circuitry at one point in time and reused by a second circuit in the first circuitry, or by a third circuit in a second circuitry at a different time.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1220 may include an output interface, such as an interface connected to a display device, an input interface such as an interface connected to an alphanumeric input device or a user interface (UI) navigation device, or a communication interface. In some examples, a connected I/O device may also include a display device, an alphanumeric input device, and/or a navigation device that is integrated into a single unit, such as a touch screen display. The communication interface may provide a connection with a network interface device used to transmit and/or receive electronic signals on the network 1226. The programmable circuitry platform 1200 may also include other interfaces or hardware in connection with a signal generation device (e.g., an audio or radio signal generation device), an output controller (e.g., for connection with a serial, universal serial bus (USB), parallel, and/or other wired or wireless connection such as which uses via infrared (IR) and/or near field communication (NFC) technologies), an input controller (e.g., for connection with sensors or peripheral devices), etc.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or a tactile output device. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1232, which may be implemented by the machine readable instructions of FIGS. 5-9, may be stored in the mass storage device 1228, in the volatile memory 1214, in the non-volatile memory 1216, and/or on at least one non-transitory computer readable storage medium such as a CD or DVD which may be removable. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1232.

The instructions 1232 may reside, during execution and/or other operation of the programmable circuitry platform 1200, completely, or at least partially, within the volatile memory 1214, within non-volatile memory 1216, within the local memory 1213, within a removable storage, within a non-removable storage, and/or within the programmable circuitry 1212. Thus, any combination of the programmable circuitry 1212, the volatile memory 1214, the non-volatile memory 1216, the local memory 1213, and/or a storage device of the removable storage or non-removable storage may constitute a machine-readable medium or media. The instructions 1232, when loaded and executed by the programmable circuitry 1212, may invoke or utilize a defined instruction set 1232 of the programmable circuitry 1212, such as a processor instruction set defined by an instruction set architecture (ISA) of a reduced instruction set computer (RISC) or complex instruction set computer (CISC) architecture-including but not limited to the RISC-V Instruction Set provided in a RISC-V architecture. A RISC-V architecture and instruction set is one of several available architectures and instruction sets that may be used in examples of the compute components (e.g., the programmable circuitry 1212) described herein.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 5-9 to effectively instantiate the circuitry of FIGS. 2-4 as logic circuits to perform operations corresponding to those machine readable instructions. In some such examples, the circuitry of FIGS. 2-4 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 5-9.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer-based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

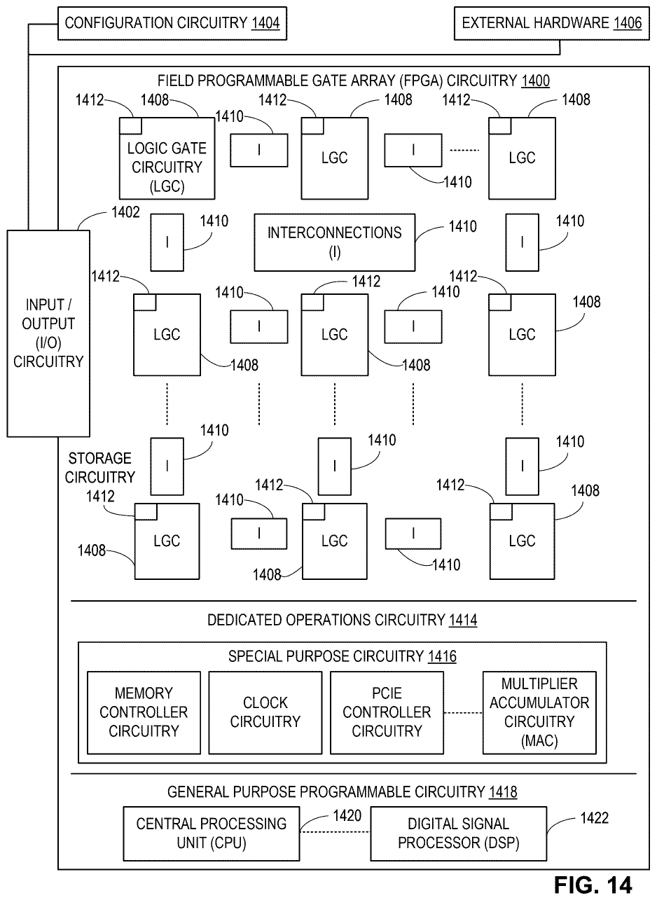

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowchart(s) of FIGS. 5-9 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5-9. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-9. As such, the FPGA circuitry 1400 may be configured and/or structured to effectively instantiate some or all of the operations/functions corresponding to the machine readable instructions of the flowchart(s) of FIGS. 5-9 as dedicated logic circuits to perform the operations/functions corresponding to those software instructions in a dedicated manner analogous to an ASIC. Therefore, the FPGA circuitry 1400 may perform the operations/functions corresponding to the some or all of the machine readable instructions of FIGS. 5-9 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine readable instructions of FIGS. 5-9 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 14. Therefore, the programmable circuitry 1212 of FIG. 12 may additionally be implemented by combining at least the example microprocessor 1300 of FIG. 13 and the example FPGA circuitry 1400 of FIG. 14. In some such hybrid examples, one or more cores 1302 of FIG. 13 may execute a first portion of the machine readable instructions represented by the flowchart(s) of FIGS. 5-9 to perform first operation(s)/function(s), the FPGA circuitry 1400 of FIG. 14 may be configured and/or structured to perform second operation(s)/function(s) corresponding to a second portion of the machine readable instructions represented by the flowcharts of FIG. 5-7, and/or an ASIC may be configured and/or structured to perform third operation(s)/function(s) corresponding to a third portion of the machine readable instructions represented by the flowcharts of FIGS. 5-9.

It should be understood that some or all of the circuitry of FIGS. 2-4 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIGS. 2-4 may be instantiated, for example, in one or more threads executing concurrently and/or in series. For example, the microprocessor 1300 of FIG. 13 may execute machine readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIGS. 2-4 may be implemented within one or more virtual machines and/or containers executing on the microprocessor 1300 of FIG. 13.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

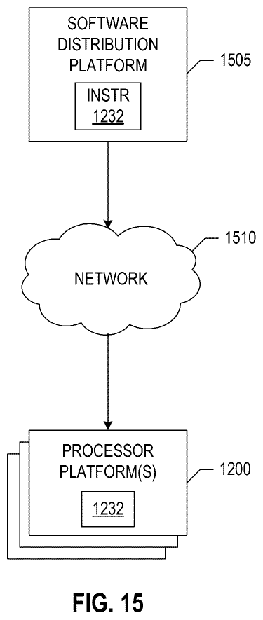

A block diagram illustrating an example software distribution platform 1505 to distribute software such as the example machine readable instructions 1232 of FIG. 12 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions of FIGS. 5-9, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions of FIG. 5-7, may be downloaded to the example programmable circuitry platform 1200, which is to execute the machine readable instructions 1232 to implement the compiler-side hint generation circuitry 126, the platform-side hint generation circuitry 136, and/or the persistent memory 144 of FIGS. 2, 3, and/or 4. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices. Although referred to as software above, the distributed “software” could alternatively be firmware.

The instructions 1232 may be transmitted or received over the network 1510 using a transmission medium via the interface circuitry 1220 of FIG. 12 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and/or wireless data networks (e.g., Institute of Electrical and Electronics Engineers (IEEE) 902.11 family of standards known as Wi-Fi®), IEEE 902.15.4 family of standards, peer-to-peer (P2P) networks, among others.

A computing program may be written in any form of programming language, including compiled or interpreted languages, and it may be deployed in any form, including as a stand-alone program and/or as a module, component, subroutine, and/or other unit suitable for use in a computing environment. Also, programs, codes, and/or code segments for accomplishing the techniques described herein are construed as within the scope of the present disclosure by programmers of ordinary skill in the art.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to generate and/or utilize operational constraint hints are disclosed herein. Further examples and combinations thereof include the following: Example 1 includes an apparatus comprising interface circuitry, instructions, and at least one programmable circuitry to be programmed by the instructions to generate an operational constraint hint based on a pragma included in programming code, and insert a machine readable instruction into an application corresponding to programming code based on the operational constraint hint.

Example 2 includes the apparatus of example 1, wherein the interface circuitry is to output the application to a platform.

Example 3 includes the apparatus of any one or more of examples 1-2, wherein the operational constraint hint corresponds to a section of the programming code likely to exhibit significant pressure on a memory address.

Example 4 includes the apparatus of example 3, wherein the operational constraint hint includes an indication of the memory address.

Example 5 includes the apparatus of any one or more of examples 1-4, wherein the operational constraint hint is a first operational constraint hint, one or more of the at least one programmable circuitry to generate a second operational constraint hint based on a comment in the programming code.

Example 6 includes the apparatus of any one or more of examples 1-5, wherein the operational constraint hint is a first operational constraint hint, one or more of the at least one programmable circuitry to generate a second operational constraint hint based on a structure of the programming code.

Example 7 includes the apparatus of any one or more of examples 1-6, wherein the operational constraint hint is a compiler-generated operational constraint hint, one or more of the at least one programmable circuitry to further instantiate memory access monitoring circuitry to, during runtime of the application increment a count for a memory address based on an eviction of data corresponding to the memory address, and generate a platform-generated operational constraint hint for the memory address based on the count.

Example 8 includes the apparatus of example 7, wherein the interface circuitry is first interface circuitry, the apparatus including second interface circuitry to transmit at least one of the compiler-generated operational constraint hint or the platform-generated operational constraint hint to a memory controller to perform operation condition leveling based on the at least one of the compiler-generated operational constraint hint or the platform-generated operational constraint hint.

Example 9 includes the apparatus of any one or more of examples 7-8, wherein one or more of the at least one programmable circuitry is to generate the platform-generated operational constraint hint for the memory address based on an eviction rate corresponding to the memory address, the eviction rate based on the count and a duration of time.

Example 10 includes the apparatus of any one or more of examples 1-9, wherein the pragma is a compiler directive.

Example 11 includes a non-transitory machine readable storage medium comprising instructions to cause at least one programmable circuitry to at least generate an operational constraint hint based on a comment included in programming code, and insert machine instruction into application corresponding to programming code based on the operational constraint hint.

Example 12 includes the non-transitory machine readable storage medium of example 11, wherein the operational constraint hint corresponds to a section of the programming code likely to exhibit significant pressure on a memory address.

Example 13 includes the non-transitory machine readable storage medium of example 12, wherein the operational constraint hint includes an indication of the memory address.

Example 14 includes the apparatus of any one or more of examples 11-13, wherein the operational constraint hint is a first operational constraint hint, the instructions to cause one or more of the at least one programmable circuitry to generate a second operational constraint hint based on a pragma in the programming code.

Example 15 includes the apparatus of any one or more of examples 11-14, wherein the operational constraint hint is a first operational constraint hint, the instructions to cause one or more of the at least one programmable circuitry to generate a second operational constraint hint based on a structure of the programming code.

Example 16 includes the apparatus of any one or more of examples 11-15, wherein the operational constraint hint is a compiler-generated operational constraint hint, the instructions to cause one or more of the at least one programmable circuitry to, during runtime of the application increment a count for a memory address based on an eviction of data corresponding to the memory address, and generate a platform-generated operational constraint hint for the memory address based on the count.

Example 17 includes the non-transitory machine readable storage medium of example 16, wherein the instructions cause one or more of the at least one programmable circuitry to cause transmission of at least one of the compiler-generated operational constraint hint or the platform-generated operational constraint hint to persistent memory via a memory controller, the persistent memory to perform operation condition leveling based on the at least one of the compiler-generated operational constraint hint or the platform-generated operational constraint hint.

Example 18 includes the apparatus of any one or more of examples 16-17, wherein the instructions cause one or more of the at least one programmable circuitry to generate the platform-generated operational constraint hint for the memory address based on an eviction rate corresponding to the memory address, the eviction rate based on the count and a duration of time.

Example 19 includes a method comprising generating, by executing an instruction with programmable circuitry, an operational constraint hint based on a pragma included in programming code, and inserting, by executing an instruction with the programmable circuitry, a machine readable instruction into an application corresponding to programming code based on the operational constraint hint.

Example 20 includes the method of example 19, further including outputting the application to a platform.

Example 21 includes the method of any one or more of examples 19-20, wherein the operational constraint hint corresponds to a section of the programming code likely to exhibit significant pressure on a memory address.

Example 22 includes the method of example 21, wherein the operational constraint hint includes an indication of the memory address.

Example 23 includes the method of any one or more of examples 19-22, wherein the operational constraint hint is a first operational constraint hint, further including generating a second operational constraint hint based on a comment in the programming code.

Example 24 includes the method of any one or more of examples 19-23, wherein the operational constraint hint is a first operational constraint hint, further including generating a second operational constraint hint based on a structure of the programming code.

Example 25 includes the method of any one or more of examples 19-24, wherein the operational constraint hint is a compiler-generated operational constraint hint, further including, during runtime of the application incrementing a count for a memory address based on an eviction of data corresponding to the memory address, and generating a platform-generated operational constraint hint for the memory address based on the count.

Example 26 includes the method of example 25, further including transmitting at least one of the compiler-generated operational constraint hint or the platform-generated operational constraint hint to a memory controller to perform operation condition leveling based on the at least one of the compiler-generated operational constraint hint or the platform-generated operational constraint hint.

Example 27 includes the method of any one or more of examples 25-26, wherein the generating of the platform-generated operational constraint hint for the memory address is based on an eviction rate corresponding to the memory address, the eviction rate based on the count and a duration of time.

Example 28 includes a system comprising a compiler to identify a first operational constraint for a first memory line referenced in programming code, compile the programming code into an application including a machine instruction, and a platform to, during runtime of the application monitor a number of evictions corresponding to a second memory line, and identify a second operational constraint for the second memory line based on the number of evictions, and circuitry to perform operation condition leveling on a persistent memory based on at least one of the first operational constraint or the second operational constraint.

Example 29 includes the system of example 28, wherein the circuitry is to perform the operation condition leveling by merging write operations for data corresponding to at least one of the first memory line or the second memory line in a buffer before flushing the data to the persistent memory.

Example 30 includes the apparatus of any one or more of examples 28-29, wherein the first memory line is the second memory line.

Example 31 includes the apparatus of any one or more of examples 28-30, wherein the persistent memory is a storage class memory.

Example 32 includes the apparatus of any one or more of examples 28-31, wherein the circuitry is to perform read throttling based on at least one of the first operational constraint, the second operational constraint or telemetry data corresponding to the persistent memory.

Example 33 includes the apparatus of any one or more of examples 28-32, wherein the circuitry is to perform prefetching based on at least one of the first operational constraint, the second operational constraint or telemetry data corresponding to the persistent memory.

Example 34 includes the apparatus of any one or more of examples 28-33, wherein the first operational constraint corresponds to large write pressure.

Example 35 includes a non-transitory machine readable storage medium comprising instructions to cause at least one programmable circuitry to at least identify a first operational constraint for a first memory line referenced in the programming code, compile the programming code into an application, and insert a machine instruction corresponding to the first operational constraint into the application, during runtime of the application monitor a number of evictions corresponding to a second memory line, and identify a second operational constraint for the second memory line based on the number of evictions, and perform operation condition leveling on a persistent memory based on at least one of the first operational constraint or the second operational constraint.

Example 36 includes the non-transitory machine readable storage medium of example 35, wherein the instructions cause one or more of the at least one programmable circuitry to perform the operation condition leveling by merging write operations for data corresponding to at least one of the first memory line or the second memory line in a buffer before flushing the data to the persistent memory.

Example 37 includes the apparatus of any one or more of examples 35-36, wherein the first memory line is the second memory line.

Example 38 includes the apparatus of any one or more of examples 35-37, wherein the persistent memory is a storage class memory.

Example 39 includes the apparatus of any one or more of examples 35-38, wherein the instructions cause one or more of the at least one programmable circuitry to perform read throttling based on at least one of the first operational constraint, the second operational constraint or telemetry data corresponding to the persistent memory.

Example 40 includes the apparatus of any one or more of examples 35-39, wherein the instructions cause one or more of the at least one programmable circuitry to perform prefetching based on at least one of the first operational constraint, the second operational constraint or telemetry data corresponding to the persistent memory.

Example 41 includes the apparatus of any one or more of examples 35-40, wherein the first operational constraint corresponds to large write pressure.

Example 42 includes a method comprising generating a first operational constraint hint based on programming code, the first operational constraint hint identifying a first memory line referenced in the programming code, the first operational constraint hint corresponding to larger write pressure, compiling the programming code into an application, and inserting a machine instruction corresponding to the first operational constraint hint into the application, during runtime of the application monitoring a number of evictions corresponding to a second memory line, and generating a second operational constraint hint for the second memory line based on the number of evictions, and performing operation condition leveling on a persistent memory based on at least one of the first operational constraint hint or the second operational constraint hint.

Example 43 includes the method of example 42, wherein the performing of the operation condition leveling includes merging write operations for data corresponding to at least one of the first memory line or the second memory line in a buffer before flushing the data to the persistent memory.

Example 44 includes the method of any one or more of examples 42-43, wherein the first memory line is the second memory line.

Example 45 includes the method of any one or more of examples 42-44, wherein the persistent memory is a storage class memory.

Example 46 includes the method of any one or more of examples 42-45, further including performing read throttling based on at least one of the first operational constraint hint, the second operational constraint hint or telemetry data corresponding to the persistent memory.

Example 47 includes the method of any one or more of examples 42-46, further including prefetching based on at least one of the first operational constraint hint, the second operational constraint hint or telemetry data corresponding to the persistent memory.

From the foregoing, it will be appreciated that example systems, apparatus, articles of manufacture, and methods have been disclosed that generate and/or utilize hints in tiered memories and storage. Disclosed systems, apparatus, articles of manufacture, and methods improve the efficiency of using a computing device by proactively generating operational constraint hints that identify memory ranges that will likely experience significant write pressure (which may reduce the useful life of a memory, such as a SCM) based on programmer code and/or execution of the programmer code. Examples disclosed herein can perform operation condition leveling techniques to reduce the number of writes to persistent memory, thereby increasing the life of the persistent memory. Accordingly, examples disclosed herein increase the life of persistent memory, thereby increasing the functionality of a real word device. Disclosed systems, apparatus, articles of manufacture, and methods are accordingly directed to one or more improvement(s) in the operation of a machine such as a memory, computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
instructions; and
at least one programmable circuitry to be programmed by the instructions to:
generate operational constraint hint information based on a pragma included in programming code; and
insert a machine readable instruction into an application corresponding to the programming code based on the operational constraint hint information.

2. The apparatus of claim 1, wherein the interface circuitry is to output the application to a platform.

3. The apparatus of claim 1, wherein the operational constraint hint information corresponds to a section of the programming code likely to repeatedly access a memory address.

4. The apparatus of claim 3, wherein the operational constraint hint information includes an indication of the memory address.

5. The apparatus of claim 1, wherein the operational constraint hint information includes a first operational constraint hint, one or more of the at least one programmable circuitry to generate a second operational constraint hint based on a comment in the programming code.

6. The apparatus of claim 1, wherein the operational constraint hint information includes a first operational constraint hint, one or more of the at least one programmable circuitry to generate a second operational constraint hint based on a structure of the programming code.

7. The apparatus of claim 1, wherein the operational constraint hint information is compiler-generated operational constraint hint information, one or more of the at least one programmable circuitry to further instantiate memory access monitoring circuitry to, during runtime of the application:
increment a count for a memory address based on an eviction of data corresponding to the memory address; and
generate platform-generated operational constraint hint information for the memory address based on the count.

8. The apparatus of claim 7, wherein the interface circuitry is first interface circuitry, the apparatus including second interface circuitry to transmit at least one of the compiler-generated operational constraint hint information or the platform-generated operational constraint hint information to a memory controller to perform operation condition leveling based on the at least one of the compiler-generated operational constraint hint information or the platform-generated operational constraint hint information.

9. The apparatus of claim 7, wherein one or more of the at least one programmable circuitry is to generate the platform-generated operational constraint hint information for the memory address based on an eviction rate corresponding to the memory address, the eviction rate based on the count and a duration of time.

10. The apparatus of claim 1, wherein the pragma is a compiler directive.

11. A non-transitory machine readable storage medium comprising instructions to cause at least one programmable circuitry to at least:
generate operational constraint hint information based on a comment included in programming code; and
insert a machine instruction into an application corresponding to the programming code based on the operational constraint hint information.

12. The non-transitory machine readable storage medium of claim 11, wherein the operational constraint hint information corresponds to a section of the programming code likely to repeatedly access a memory address.

13. The non-transitory machine readable storage medium of claim 12, wherein the operational constraint hint information includes an indication of the memory address.

14. The non-transitory machine readable storage medium of claim 11, wherein the operational constraint hint information includes a first operational constraint hint, the instructions to cause one or more of the at least one programmable circuitry to generate a second operational constraint hint based on a pragma in the programming code.

15. The non-transitory machine readable storage medium of claim 11, wherein the operational constraint hint information includes a first operational constraint hint, the instructions to cause one or more of the at least one programmable circuitry to generate a second operational constraint hint based on a structure of the programming code.

16. The non-transitory machine readable storage medium of claim 11, wherein the operational constraint hint information is compiler-generated operational constraint hint information, the instructions to cause one or more of the at least one programmable circuitry to, during runtime of the application:
increment a count for a memory address based on an eviction of data corresponding to the memory address; and
generate platform-generated operational constraint hint information for the memory address based on the count.

17. The non-transitory machine readable storage medium of claim 16, wherein the instructions cause one or more of the at least one programmable circuitry to cause transmission of at least one of the compiler-generated operational constraint hint information or the platform-generated operational constraint hint information to persistent memory via a memory controller, the persistent memory to perform operation condition leveling based on the at least one of the compiler-generated operational constraint hint information or the platform-generated operational constraint hint information.

18. The non-transitory machine readable storage medium of claim 16, wherein the instructions cause one or more of the at least one programmable circuitry to generate the platform-generated operational constraint hint information for the memory address based on an eviction rate corresponding to the memory address, the eviction rate based on the count and a duration of time.

19. (canceled)

20. (canceled)

21. (canceled)

22. (canceled)

23. (canceled)

24. (canceled)

25. (canceled)

26. (canceled)

27. (canceled)

28. A system comprising:
a compiler to:
identify a first operational constraint for a first memory line referenced in programming code;
compile the programming code into an application including a machine instruction; and
a platform to, during runtime of the application:
monitor a number of evictions corresponding to a second memory line; and
identify a second operational constraint for the second memory line based on the number of evictions; and
circuitry to perform operation condition leveling on a persistent memory based on at least one of the first operational constraint or the second operational constraint.

29. The system of claim 28, wherein the circuitry is to perform the operation condition leveling by merging write operations for data corresponding to at least one of the first memory line or the second memory line in a buffer before flushing the data to the persistent memory.

30. The system of claim 28, wherein the first memory line is the second memory line.

31. The system of claim 28, wherein the persistent memory is a storage class memory.

32. The system of claim 28, wherein the circuitry is to perform read throttling based on at least one of the first operational constraint, the second operational constraint or telemetry data corresponding to the persistent memory.

33. The system of claim 28, wherein the circuitry is to perform prefetching based on at least one of the first operational constraint, the second operational constraint or telemetry data corresponding to the persistent memory.

34. The system of claim 28, wherein the first operational constraint corresponds to large write pressure.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)
